(19) United States
(12) Patent Application Publication
(10) Pub. No.: US 2021/0203997 A1
(43) Pub. Date: Jul. 1, 2021

(54) HYBRID VIDEO AND FEATURE CODING AND DECODING

(71) Applicant: Huawei Technologies Co., Ltd., Shenzhen (CN)

(72) Inventors: Anton Igorevich VESELOV, Saint (RU); Hu CHEN, Munich (DE); Francesco ROMANO, Munich (DE); Zhijie ZHAO, Munich (DE); Marat Ravilevich GILMUTDINOV, Saint (RU)

(21) Appl. No.: 17/197,500

(22) Filed: Mar. 10, 2021

Related U.S. Application Data
(63) Continuation of application No. PCT/RU2018/000592, filed on Sep. 10, 2018.

(51) Int. Cl. H04N 19/70; H04N 19/184; G06K 9/46

(52) U.S. Cl. CPC H04N 19/70; G06K 9/4671; H04N 19/184

(57) ABSTRACT

The present disclosure relates to hybrid video and feature encoding and decoding, with the encoding and decoding of the image feature being performed independently or differentially. The video and feature are encoded and decoded in separate layers, e.g., base layer and enhancement layer. The feature is extracted for a frame of the video, providing a frame-based feature-video association. A feature is extracted from an uncompressed video encoded in an enhancement layer into a feature bitstream. The video is encoded into a video bitstream, with the feature bitstream being embedded into the video bitstream by multiplexing both streams into an output bitstream. The image feature, which may be a differential image feature, is included in a sequence enhancement information SEI message of a frame header information of the video. The output bitstream is provided as input bitstream to a decoder, which de-multiplexes the input bitstream into a video bitstream and feature bitstream, using the SEI message of the frame header. Both bitstreams are decoded in their respective layers, and the image feature is located in the video using the frame-based feature-video association.

### CROSS-REFERENCE TO RELATED APPLICATIONS

This application is a continuation of International Application No. PCT/RU2018/000592, filed on Sep. 10, 2018, the disclosure of which is hereby incorporated by reference in its entirety.

### TECHNICAL FIELD

The present disclosure relates to hybrid encoding and decoding of video images and image features of video images.

### BACKGROUND

Video coding (video encoding and decoding) is used in a wide range of digital video applications, for example broadcast digital TV, video transmission over internet and mobile networks, real-time conversational applications such as video chat, video conferencing, DVD and Blu-ray discs, video content acquisition and editing systems, and camcorders of security applications.

Since the development of the block-based hybrid video coding approach in the H.261 standard in 1990, new video coding techniques and tools were developed and formed the basis for new video coding standards. One of the goals of most of the video coding standards was to achieve a bitrate reduction compared to its predecessor without sacrificing picture quality. Further video coding standards comprise MPEG-1 video, MPEG-2 video, ITU-T H.262/MPEG-2, ITU-T H.263, ITU-T H.264/MPEG-4, Part 10, Advanced Video Coding (AVC), ITU-T H.265, High Efficiency Video Coding (HEVC), and extensions, e.g. scalability and/or three-dimensional (3D) extensions, of these standards.

The encoding and decoding, i.e. the compression and decompressions of video images is also relevant for applications, for example, in video surveillance, where still and/or moving target objects need to be detected and identified. In present video surveillance solutions, videos are compressed at the terminal side (user or client), for example, at the camera or the like, and transmitted to servers, which may be part of a cloud. At the cloud side, the compressed video are then reconstructed and analyzed further. The encoding and decoding of the video may be performed by standard video encoders and decoders, as shown in FIGS. 1 to 4, compatible with H.264/AVC or HEVC (H.265) or next generations, for example.

On one hand, computer vision CV algorithms, for example, for object detection or face recognition, are used to extract useful information from the videos, i.e. the video images. The typical detection and recognition CV algorithms are fundamentally based on features extracted from the videos, or more accurately speaking, from the individual frames of the video sequences. Features include conventional ones, such as scale invariant feature transform SIFT, speeded up robust features SURF, and binary robust independent elementary features BRIEF, or in recent years convolutional neural network CNN-based features. The latter type of features may be more generally referred to as machine-learning features, i.e. features extracted and/or classified by machine-learning models, including CNNs or the like. On the other hand, humans are also employed to watch the videos in order to either look for information that CV algorithms might miss or in order to prove the correctness of the CV algorithms' results. However, humans do not understand the features, which CV algorithms use to perform video image analysis, so that humans actually watch the videos at the server side (cloud). Therefore, in video surveillance, a video is (en)coded and transmitted (e.g. uploaded to a cloud server), and high quality features are also used for CV algorithms to provide fast and accurate image analysis results.

### SUMMARY

Embodiments of the invention are defined by the features of the independent claims, and further advantageous implementations of the embodiments by the features of the dependent claims.

According to an aspect of the present disclosure, an apparatus is provided for encoding a video comprising a processing circuitry configured to encode the video into a video bitstream; extract an image feature from the video; encode the image feature into a feature bitstream; and multiplex the feature bitstream and the video bitstream into an output bitstream.

The extraction of an image feature from the uncompressed, i.e. original video provides the advantage of high-quality features, which may be used in subject and object identification in video surveillance. The use of high-quality features thus allows to make object detection and identification in particular more accurate and reliable, which are key tasks as performed by computer vision algorithms and applied in systems of video surveillance, computer vision driven feature coding, and autonomous driving.

The extraction of one or a plurality of images features from the lossless uncompressed video at the encoder side (i.e. terminal side) allows further to perform computer vision tasks at the terminal side and thus accelerates the final computer vision analysis at the decoder side (cloud).

According to an aspect of the present disclosure, the processing circuitry of the apparatus is further configured to extract the image feature for a frame of the video.

According to an aspect of the present disclosure, the processing circuitry is further configured to multiplex the feature bitstream and the video bitstream into the output bitstream, wherein the multiplexing defines an association between the video bitstream pertaining to a video frame and the feature bitstream pertaining to said frame.

The frame-wise feature extraction along with the frame-based association of the feature bitstream and the video bitstream allows location of the feature in the reconstructed video based on the frame, from which the feature was extracted. This means that instead of decoding the entire video only the video frame containing the feature needs to be decoded.

In one exemplary implementation, the multiplexing includes including the image feature of the video into a sequence enhancement information SEI message belonging to frame header information of the video.

This provides the advantage of a compact structure of the video (i.e. the output bitstream), including the feature bitstream and the video bitstream. In particular, embedding the image feature into the SEI header of the video provides the advantage that the video bitstream also includes information on the feature itself, feature type, and frame index or the like. This enables a synchronization of the feature bitstream and the video bitstream, while both are encoded in different layers.

According to an aspect of the present disclosure, the processing circuitry is further configured to encode the image feature by differential encoding comprising reconstructing from the video bitstream the video; extracting the image feature from the reconstructed video; determining a differential image feature by subtracting the extracted image feature of the reconstructed video from the extracted image feature of the video; and encoding the differential image feature into the feature bitstream.

The possibility of differential encoding provides the advantage of improving the compression ratio of features by using image features extracted from the reconstructed video as predictors. In other words, the differential feature encoding is very efficient.

In one exemplary implementation, the image feature is any of scale invariant feature transform, SIFT, speeded up robust features, SURF, binary robust independent elementary features, BRIEF, or a feature extracted by machine-learning based models.

The use of different types of features along with their possible different representations (floating point, integer, or binary) allows performing computer visions tasks more accurately and reliably due to the feature diversity.

According to an aspect of the present disclosure, an apparatus is provided for reconstructing a video, the apparatus comprising a processing circuitry configured to de-multiplex an input bitstream of an encoded video into a video bitstream and a feature bitstream; decode from the video bitstream the video; decode from the feature bitstream an image feature of the video; and locate the image feature in the video.

According to one exemplary implementation, the image feature is for a frame of the video.

According to an aspect of the present disclosure, the input bitstream contains the feature bitstream and the video bitstream in a multiplexing manner, wherein the multiplexing defines an association between the video bitstream pertaining to a video frame and the feature bitstream pertaining to said frame, and the processing circuitry of the apparatus is further configured to de-multiplex the input bitstream into the video bitstream and the feature bitstream according to said frame.

In one exemplary embodiment of the disclosure, the input bitstream contains the image feature in a sequence enhancement information SEI message belonging to frame header information of the video in a multiplexing manner, and the processing circuitry is further configured to de-multiplex from the SEI message the image feature.

The frame-wise video-feature association enables a quick location of the feature in the video, respectively, the video bitstream. As a result, the video frame can be retrieved fast and used to extract one or more additional features different from the image feature included in the feature bitstream. This improves further the performance of computer vision (CV) systems using image features for CV tasks, including subject and/or object detection and identification such as face recognition using facial features for example.

According to an aspect of the present disclosure, the processing circuitry of the apparatus is further configured to decode the feature bitstream, including a differential image feature of the video, by differential decoding comprising: extracting the image feature from the reconstructed video; and determining the image feature of the video by adding the extracted image feature of the reconstructed video to the differential image feature.

According to an aspect of the present disclosure, a method is provided for encoding a video comprising the steps of encoding the video into a video bitstream; extracting an image feature from the video; encoding the image feature into a feature bitstream; and multiplexing the feature bitstream and the video bitstream into an output bitstream.

According to an aspect of the present disclosure, a method is provided for reconstructing a video, the method comprising the steps of de-multiplexing from an input bitstream a video bit-stream and a feature bit-stream; decoding from the video bitstream the video; decoding from the feature bitstream an image feature of the video; and locating the image feature in the video.

According to an aspect of the present disclosure, a computer-readable non-transitory medium is provided for storing a program, including instructions which when executed on a processor cause the processor to perform the method the method steps.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the invention are described in more detail with reference to the attached figures and drawings, in which:

FIG. 1 is a block diagram showing an example of a video encoder configured to implement embodiments of the invention.

FIG. 2 is a block diagram showing an example structure of a video decoder configured to implement embodiments of the invention.

FIG. 3 is a block diagram showing an example of a video coding system configured to implement embodiments of the invention.

FIG. 4 is a block diagram of a video coder (encoder or decoder) with its interfaces.

FIG. 5 is a block diagram of an apparatus of an embodiment, performing hybrid video and feature encoding, with independent feature encoding.

FIG. 6 is a block diagram of an apparatus of an embodiment, performing hybrid video and feature encoding, with differential feature encoding.

FIG. 7 is a block diagram of an apparatus of an embodiment, performing hybrid video and feature decoding, with independent feature decoding.

FIG. 8 is a block diagram of an apparatus of an embodiment, performing hybrid video and feature decoding, with differential feature decoding.

FIG. 9 is a block diagram of a light-weight floating-point feature encoder and decoder, including N-bit to q-bit quantization and dequantization.

FIG. 10 is a schematic drawing of face recognition, using 32-to-q bit quantized image features.

FIG. 11 is a block diagram of an arithmetic encoder and decoder for binary features.

FIG. 12 is an illustration of the syntax of the metadata container.

FIG. 13 is a block diagram of a system of a computer vision system, including a hybrid video and feature encoder and decoder, performing computer vision analysis of a video based on independently encoded/decoded image features.

FIG. 14 is a block diagram of a system of a computer vision system, including a hybrid video and feature encoder and decoder, performing computer vision analysis of a video based on differentially encoded/decoded image features.

FIG. 15 is an illustration of face recognition by use of a feature, extracted by a CNN from an image patch of an uncompressed video, and compared with pre-determined database features of known faces.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the invention or specific aspects in which embodiments of the present invention may be used. It is understood that embodiments of the invention may be used in other aspects and comprise structural or logical changes not depicted in the figures. The following detailed description, therefore, is not to be taken in a limiting sense, and the scope of the present invention is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

Video coding typically refers to the processing of a sequence of pictures, which form the video or video sequence. Instead of the term picture the terms frame or image may be used as synonyms in the field of video coding. Video coding comprises two parts, video encoding and video decoding. Video encoding is performed at the source side, typically comprising processing (e.g. by compression) the original video pictures to reduce the amount of data required for representing the video pictures (for more efficient storage and/or transmission). Video decoding is performed at the destination side and typically comprises the inverse processing compared to the encoder to reconstruct the video pictures. Embodiments referring to “coding” of video pictures (or pictures in general, as will be explained later) shall be understood to relate to both, “encoding” and “decoding” of video pictures. The combination of the encoding part and the decoding part is also referred to as CODEC (COding and DECoding).

In case of lossless video coding, the original video pictures can be reconstructed, i.e. the reconstructed video pictures have the same quality as the original video pictures (assuming no transmission loss or other data loss during storage or transmission). In case of lossy video coding, further compression, e.g. by quantization, is performed, to reduce the amount of data representing the video pictures, which cannot be completely reconstructed at the decoder, i.e. the quality of the reconstructed video pictures is lower or worse compared to the quality of the original video pictures.

Several video coding standards since H.261 belong to the group of “lossy hybrid video codecs” (i.e. combine spatial and temporal prediction in the sample domain and 2D transform coding for applying quantization in the transform domain). Each picture of a video sequence is typically partitioned into a set of non-overlapping blocks and the coding is typically performed on a block level. In other words, at the encoder the video is typically processed, i.e. encoded, on a block (video block) level, e.g. by using spatial (intra picture) prediction and temporal (inter picture) prediction to generate a prediction block, subtracting the prediction block from the current block (block currently processed/to be processed) to obtain a residual block, transforming the residual block and quantizing the residual block in the transform domain to reduce the amount of data to be transmitted (compression), whereas at the decoder the inverse processing compared to the encoder is applied to the encoded or compressed block to reconstruct the current block for representation. Furthermore, the encoder duplicates the decoder processing loop such that both will generate identical predictions (e.g. intra- and inter predictions) and/or re-constructions for processing, i.e. coding, the subsequent blocks.

As video picture processing (also referred to as moving picture processing) and still picture processing (the term processing comprising coding), share many concepts and technologies or tools, in the following the term “picture” is used to refer to a video picture of a video sequence (as explained above) and/or to a still picture to avoid unnecessary repetitions and distinctions between video pictures and still pictures, where not necessary. In case the description refers to still pictures (or still images) only, the term “still picture” shall be used.

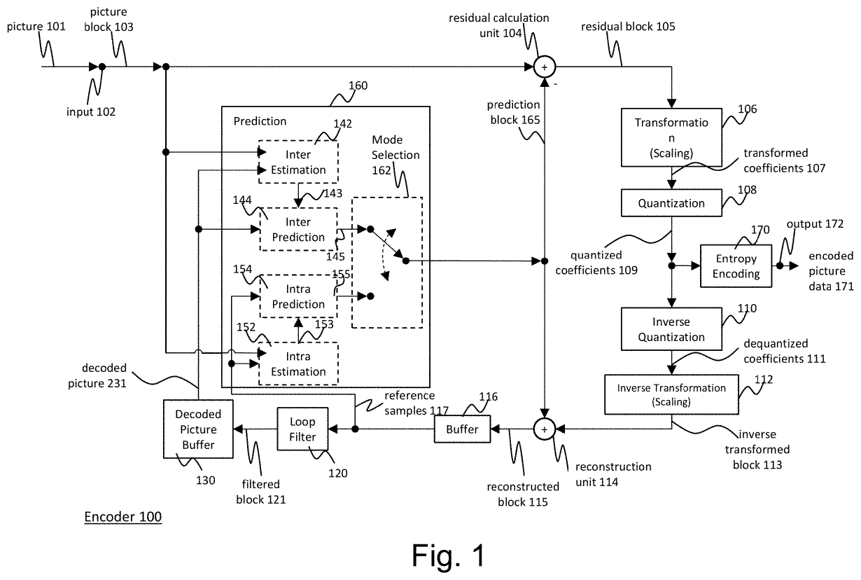

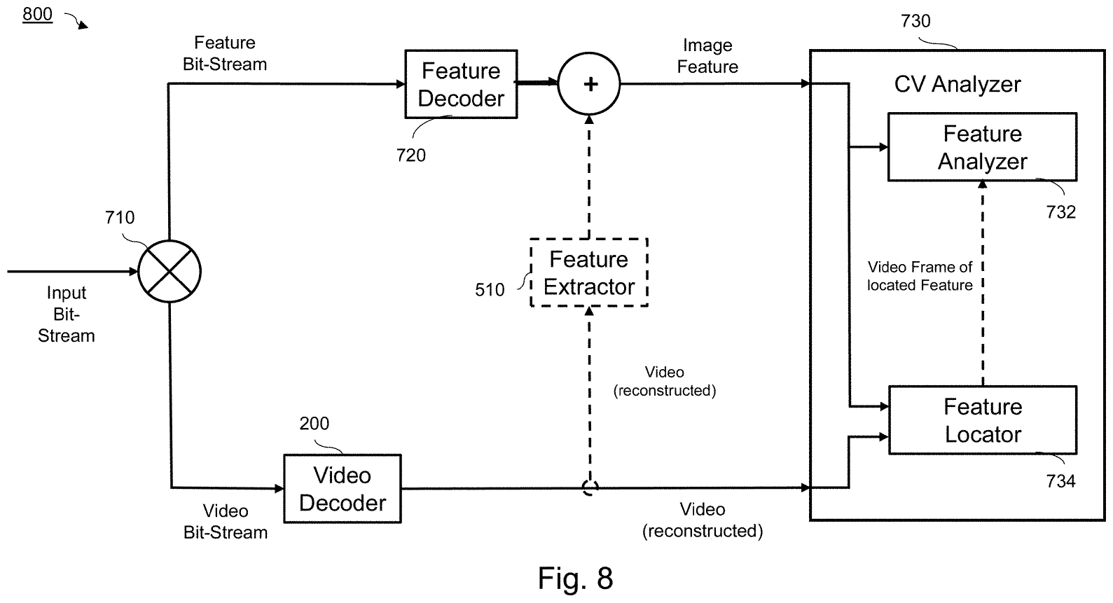

In the following, embodiments of an encoder 100, a decoder 200 and a coding system 300 are described based on FIGS. 1 to 3 (before describing embodiments of the invention in more detail based on FIGS. 8 to 12).

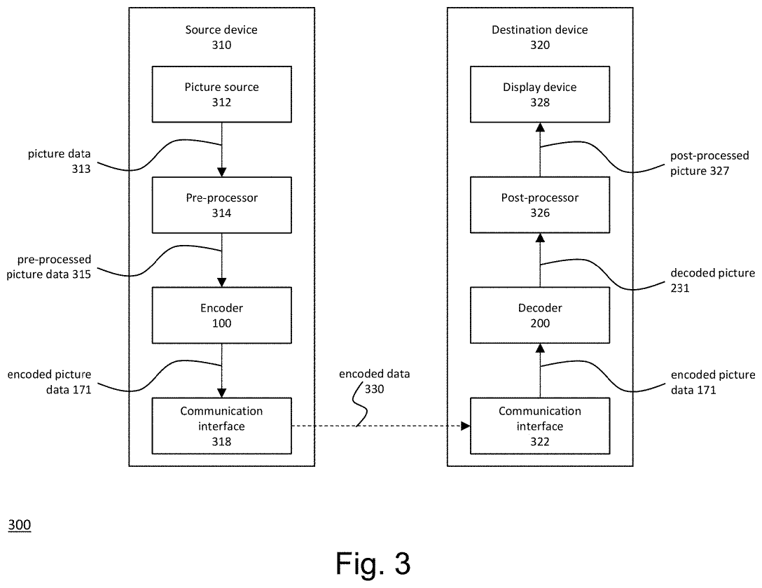

FIG. 3 is a schematic block diagram illustrating an embodiment of a coding system 300, e.g. a picture coding system 300, wherein the coding system 300 comprises a source device 310 configured to provide encoded data 330, e.g. an encoded picture 330, e.g. to a destination device 320 for decoding the encoded data 330.

The source device 310 comprises an encoder 100 or encoding unit 100, and may additionally, i.e. optionally, comprise a picture source 312, a pre-processing unit 314, e.g. a picture pre-processing unit 314, and a communication interface or communication unit 318.

The picture source 312 may comprise or be any kind of picture capturing device, for example for capturing a real-world picture, and/or any kind of a picture generating device, for example a computer-graphics processor for generating a computer animated picture, or any kind of device for obtaining and/or providing a real-world picture, a computer animated picture (e.g. a screen content, a virtual reality (VR) picture) and/or any combination thereof (e.g. an augmented reality (AR) picture). In the following, all these kinds of pictures and any other kind of picture will be referred to as “picture”, unless specifically described otherwise, while the previous explanations with regard to the term “picture” covering “video pictures” and “still pictures” still hold true, unless explicitly specified differently.

A (digital) picture is or can be regarded as a two-dimensional array or matrix of samples with intensity values. A sample in the array may also be referred to as pixel (short form of picture element) or a pel. The number of samples in horizontal and vertical direction (or axis) of the array or picture define the size and/or resolution of the picture. For representation of color, typically three color components are employed, i.e. the picture may be represented or include three sample arrays. In RBG format or color space a picture comprises a corresponding red, green and blue sample array. However, in video coding each pixel is typically represented in a luminance/chrominance format or color space, e.g. YCbCr, which comprises a luminance component indicated by Y (sometimes also L is used instead) and two chrominance components indicated by Cb and Cr. The luminance (or short luma) component Y represents the brightness or grey level intensity (e.g. like in a grey-scale picture), while the two chrominance (or short chroma) components Cb and Cr represent the chromaticity or color information components. Accordingly, a picture in YCbCr format comprises a luminance sample array of luminance sample values (Y), and two chrominance sample arrays of chrominance values (Cb and Cr). Pictures in RGB format may be converted or transformed into YCbCr format and vice versa, the process is also known as color transformation or conversion. If a picture is monochrome, the picture may comprise only a luminance sample array.

The picture source 312 may be, for example a camera for capturing a picture, a memory, e.g. a picture memory, comprising or storing a previously captured or generated picture, and/or any kind of interface (internal or external) to obtain or receive a picture. The camera may be, for example, a local or integrated camera integrated in the source device, the memory may be a local or integrated memory, e.g. integrated in the source device. The interface may be, for example, an external interface to receive a picture from an external video source, for example an external picture capturing device like a camera, an external memory, or an external picture generating device, for example an external computer-graphics processor, computer or server. The interface can be any kind of interface, e.g. a wired or wireless interface, an optical interface, according to any proprietary or standardized interface protocol. The interface for obtaining the picture data 312 may be the same interface as or a part of the communication interface 318.

In distinction to the pre-processing unit 314 and the processing performed by the pre-processing unit 314, the picture or picture data 313 may also be referred to as raw picture or raw picture data 313.

Pre-processing unit 314 is configured to receive the (raw) picture data 313 and to perform pre-processing on the picture data 313 to obtain a pre-processed picture 315 or pre-processed picture data 315. Pre-processing performed by the pre-processing unit 314 may, e.g., comprise trimming, color format conversion (e.g. from RGB to YCbCr), color correction, or de-noising.

The encoder 100 is configured to receive the pre-processed picture data 315 and provide encoded picture data 171 (further details will be described, e.g., based on FIG. 1).

Communication interface 318 of the source device 310 may be configured to receive the encoded picture data 171 and to directly transmit it to another device, e.g. the destination device 320 or any other device, for storage or direct reconstruction, or to process the encoded picture data 171 for respectively before storing the encoded data 330 and/or transmitting the encoded data 330 to another device, e.g. the destination device 320 or any other device for decoding or storing.

The destination device 320 comprises a decoder 200 or decoding unit 200, and may additionally, i.e. optionally, comprise a communication interface or communication unit 322, a post-processing unit 326 and a display device 328.

The communication interface 322 of the destination device 320 is configured receive the encoded picture data 171 or the encoded data 330, e.g. directly from the source device 310 or from any other source, e.g. a memory, e.g. an encoded picture data memory.

The communication interface 318 and the communication interface 322 may be configured to transmit respectively receive the encoded picture data 171 or encoded data 330 via a direct communication link between the source device 310 and the destination device 320, e.g. a direct wired or wireless connection, or via any kind of network, e.g. a wired or wireless network or any combination thereof, or any kind of private and public network, or any kind of combination thereof.

The communication interface 318 may be, e.g., configured to package the encoded picture data 171 into an appropriate format, e.g. packets, for transmission over a communication link or communication network, and may further comprise data loss protection and data loss recovery.

The communication interface 322, forming the counterpart of the communication interface 318, may be, e.g., configured to de-package the encoded data 330 to obtain the encoded picture data 171 and may further be configured to perform data loss protection and data loss recovery, e.g. comprising error concealment.

Both, communication interface 318 and communication interface 322 may be configured as unidirectional communication interfaces as indicated by the arrow for the encoded picture data 330 in FIG. 3 pointing from the source device 310 to the destination device 320, or bi-directional communication interfaces, and may be configured, e.g. to send and receive messages, e.g. to set up a connection, to acknowledge and/or re-send lost or delayed data including picture data, and exchange any other information related to the communication link and/or data transmission, e.g. encoded picture data transmission.

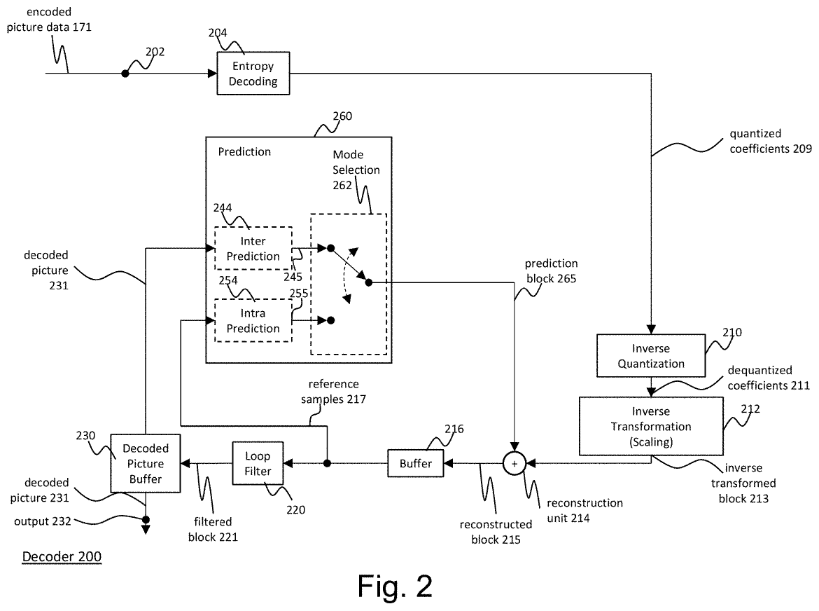

The decoder 200 is configured to receive the encoded picture data 171 and provide decoded picture data 231 or a decoded picture 231 (further details will be described, e.g., based on FIG. 2).

The post-processor 326 of destination device 320 is configured to post-process the decoded picture data 231, e.g. the decoded picture 231, to obtain post-processed picture data 327, e.g. a post-processed picture 327. The post-processing performed by the post-processing unit 326 may comprise, e.g. color format conversion (e.g. from YCbCr to RGB), color correction, trimming, or re-sampling, or any other processing, e.g. for preparing the decoded picture data 231 for display, e.g. by display device 328.

The display device 328 of the destination device 320 is configured to receive the post-processed picture data 327 for displaying the picture, e.g. to a user or viewer. The display device 328 may be or comprise any kind of display for representing the reconstructed picture, e.g. an integrated or external display or monitor. The displays may, e.g. comprise cathode ray tubes (CRT), liquid crystal displays (LCD), plasma displays, organic light emitting diodes (OLED) displays or any kind of other display, such as beamer, hologram (3D), or the like.

Although FIG. 3 depicts the source device 310 and the destination device 320 as separate devices, embodiments of devices may also comprise both or both functionalities, the source device 310 or corresponding functionality and the destination device 320 or corresponding functionality. In such embodiments the source device 310 or corresponding functionality and the destination device 320 or corresponding functionality may be implemented using the same hardware and/or software or by separate hardware and/or software or any combination thereof.

As will be apparent for the skilled person based on the description, the existence and (exact) split of functionalities of the different units or functionalities within the source device 310 and/or destination device 320 as shown in FIG. 3 may vary depending on the actual device and application.

Therefore, the source device 310 and the destination device 320 as shown in FIG. 3 are just example embodiments of the invention and embodiments of the invention are not limited to those shown in FIG. 3.

Source device 310 and destination device 320 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices, broadcast receiver device, or the like and may use no or any kind of operating system.

### Encoder and Encoding Method

FIG. 1 shows a schematic block diagram of an embodiment of an encoder 100, e.g. a picture encoder 100, which comprises an input 102, a residual calculation unit 104, a transformation unit 106, a quantization unit 108, an inverse quantization unit 110, and inverse transformation unit 112, a reconstruction unit 114, a buffer 118, a loop filter 120, a decoded picture buffer (DPB) 130, a prediction unit 160, an inter estimation unit 142, an inter prediction unit 144, an intra-estimation unit 152, an intra-prediction unit 154, a mode selection unit 162, an entropy encoding unit 170, and an output 172. A video encoder 100 as shown in FIG. 1 may also be referred to as hybrid video encoder or a video encoder according to a hybrid video codec.

For example, the residual calculation unit 104, the transformation unit 106, the quantization unit 108, and the entropy encoding unit 170 form a forward signal path of the encoder 100, whereas, for example, the inverse quantization unit 110, the inverse transformation unit 112, the reconstruction unit 114, the buffer 118, the loop filter 120, the decoded picture buffer (DPB) 130, the inter prediction unit 144, and the intra-prediction unit 154 form a backward signal path of the encoder, wherein the backward signal path of the encoder corresponds to the signal path of the decoder (see decoder 200 in FIG. 2).

The encoder is configured to receive, e.g. by input 102, a picture 101 or a picture block 103 of the picture 101, e.g. picture of a sequence of pictures forming a video or video sequence. The picture block 103 may also be referred to as current picture block or picture block to be coded, and the picture 101 as current picture or picture to be coded (in particular in video coding to distinguish the current picture from other pictures, e.g. previously encoded and/or decoded pictures of the same video sequence, i.e. the video sequence which also comprises the current picture).

Embodiments of the encoder 100 may comprise a partitioning unit (not depicted in FIG. 1), e.g. which may also be referred to as picture partitioning unit, configured to partition the picture 103 into a plurality of blocks, e.g. blocks like block 103, typically into a plurality of non-overlapping blocks. The partitioning unit may be configured to use the same block size for all pictures of a video sequence and the corresponding grid defining the block size, or to change the block size between pictures or subsets or groups of pictures, and partition each picture into the corresponding blocks.

For example, in HEVC, the picture is subdivided into so-called coding tree units, CTUs. CTUs have the same size, which may be determined by some signaling parameters or fixed by standard. CTUs typically do not overlap. Each CTU may then be further split into coding and/or transform units, i.e. blocks for which prediction and/or transformation is performed, respectively. The splitting is performed recursively by providing possibility to divide each block further in four further blocks (quad-tree partitioning) or two further blocks (binary-tree partitioning) or any other kind of partitioning. In other words, HEVC established CTU as a root for the tree-based hierarchical splitting, such as quad-tree splitting of CTUs and CUs to four square CUs until a maximum depth, corresponding to minimum size a CU is allowed to take. The decision on whether a CTU is split and into which depth for each of the CTU's blocks may be taken by rate-distortion optimization. However, in general, the splitting may also be defined based on other criteria, such as presence of edges in the CTU, or the like. Accordingly, in the present disclosure, when referring to “block” or “unit” as a part of the image, CTU or any units obtained by CTU splitting—square or rectangular without being square—are meant. In general, embodiments are possible, in which the block may overlap.

Like the picture 101, the block 103 again is or can be regarded as a two-dimensional array or matrix of samples with intensity values (sample values), although of smaller dimension than the picture 101. In other words, the block 103 may comprise, e.g., one sample array (e.g. a luma array in case of a monochrome picture 101) or three sample arrays (e.g. a luma and two chroma arrays in case of a color picture 101) or any other number and/or kind of arrays depending on the color format applied. The number of samples in horizontal and vertical direction (or axis) of the block 103 define the size of block 103.

Encoder 100 as shown in FIG. 1 is configured encode the picture 101 block by block, e.g. the encoding and prediction is performed per block 103.

The residual calculation unit 104 is configured to calculate a residual block 105 based on the picture block 103 and a prediction block 165 (further details about the prediction block 165 are provided later), e.g. by subtracting sample values of the prediction block 165 from sample values of the picture block 103, sample by sample (pixel by pixel) to obtain the residual block 105 in the sample domain. Residual values (forming residual signal) correspond to prediction error (prediction error signal).

The transformation unit 106 is configured to apply a transformation, e.g. a spatial frequency transform or a linear spatial (frequency) transform, e.g. a discrete cosine transform (DCT) or discrete sine transform (DST), on the sample values of the residual block 105 to obtain transformed coefficients 107 in a transform domain. The transformed coefficients 107 may also be referred to as transformed residual coefficients and represent the residual block 105 in the transform domain.

The transformation unit 106 may be configured to apply integer approximations of DCT/DST, such as the core transforms specified for HEVC/H.265. Compared to an orthonormal DCT transform, such integer approximations are typically scaled by a certain factor. In order to preserve the norm of the residual block which is processed by forward and inverse transforms, additional scaling factors are applied as part of the transform process. The scaling factors are typically chosen based on certain constraints like scaling factors being a power of two for shift operation, bit depth of the transformed coefficients, tradeoff between accuracy and implementation costs, etc. Specific scaling factors are, for example, specified for the inverse transform, e.g. by inverse transformation unit 212, at a decoder 200 (and the corresponding inverse transform, e.g. by inverse transformation unit 112 at an encoder 100) and corresponding scaling factors for the forward transform, e.g. by transformation unit 106, at an encoder 100 may be specified accordingly.

The quantization unit 108 is configured to quantize the transformed coefficients 107 to obtain quantized coefficients 109, e.g. by applying scalar quantization or vector quantization. The quantized coefficients 109 may also be referred to as quantized residual coefficients 109. For example for scalar quantization, different scaling may be applied to achieve finer or coarser quantization. Smaller quantization step sizes correspond to finer quantization, whereas larger quantization step sizes correspond to coarser quantization. The applicable quantization step size may be indicated by a quantization parameter (QP). The quantization parameter may for example be an index to a predefined set of applicable quantization step sizes. For example, small quantization parameters may correspond to fine quantization (small quantization step sizes) and large quantization parameters may correspond to coarse quantization (large quantization step sizes) or vice versa. The quantization may include division by a quantization step size and corresponding or inverse dequantization, e.g. by inverse quantization 110, may include multiplication by the quantization step size. Embodiments according to HEVC, may be configured to use a quantization parameter to determine the quantization step size. Generally, the quantization step size may be calculated based on a quantization parameter using a fixed point approximation of an equation including division. Additional scaling factors may be introduced for quantization and dequantization to restore the norm of the residual block, which might get modified because of the scaling used in the fixed point approximation of the equation for quantization step size and quantization parameter. In one example implementation, the scaling of the inverse transform and dequantization might be combined. Alternatively, customized quantization tables may be used and signaled from an encoder to a decoder, e.g. in a bitstream. The quantization is a lossy operation, wherein the loss increases with increasing quantization step sizes.

Embodiments of the encoder 100 (or respectively of the quantization unit 108?) may be configured to output the quantization scheme and quantization step size, e.g. by means of the corresponding quantization parameter, so that a decoder 200 may receive and apply the corresponding inverse quantization. Embodiments of the encoder 100 (or quantization unit 108) may be configured to output the quantization scheme and quantization step size, e.g. directly or entropy encoded via the entropy encoding unit 170 or any other entropy coding unit.

The inverse quantization unit 110 is configured to apply the inverse quantization of the quantization unit 108 on the quantized coefficients to obtain dequantized coefficients 111, e.g. by applying the inverse of the quantization scheme applied by the quantization unit 108 based on or using the same quantization step size as the quantization unit 108. The dequantized coefficients 111 may also be referred to as dequantized residual coefficients 111 and correspond—although typically not identical to the transformed coefficients due to the loss by quantization—to the transformed coefficients 108.

The inverse transformation unit 112 is configured to apply the inverse transformation of the transformation applied by the transformation unit 106, e.g. an inverse discrete cosine transform (DCT) or inverse discrete sine transform (DST), to obtain an inverse transformed block 113 in the sample domain. The inverse transformed block 113 may also be referred to as inverse transformed dequantized block 113 or inverse transformed residual block 113.

The reconstruction unit 114 is configured to combine the inverse transformed block 113 and the prediction block 165 to obtain a reconstructed block 115 in the sample domain, e.g. by sample wise adding the sample values of the decoded residual block 113 and the sample values of the prediction block 165.

The buffer unit 116 (or short “buffer” 116), e.g. a line buffer 116, is configured to buffer or store the reconstructed block and the respective sample values, for example for intra estimation and/or intra prediction. In further embodiments, the encoder may be configured to use unfiltered reconstructed blocks and/or the respective sample values stored in buffer unit 116 for any kind of estimation and/or prediction.

Embodiments of the encoder 100 may be configured such that, e.g. the buffer unit 116 is not only used for storing the reconstructed blocks 115 for intra estimation 152 and/or intra prediction 154 but also for the loop filter unit 120 (not shown in FIG. 1), and/or such that, e.g. the buffer unit 116 and the decoded picture buffer unit 130 form one buffer. Further embodiments may be configured to use filtered blocks 121 and/or blocks or samples from the decoded picture buffer 130 (both not shown in FIG. 1) as input or basis for intra estimation 152 and/or intra prediction 154.

The loop filter unit 120 (or short “loop filter” 120), is configured to filter the reconstructed block 115 to obtain a filtered block 121, e.g. by applying a de-blocking filter, sample-adaptive offset (SAO) filter or other filters, e.g. sharpening or smoothing filters or collaborative filters. The filtered block 121 may also be referred to as filtered reconstructed block 121.

Embodiments of the loop filter unit 120 may comprise (not shown in FIG. 1) a filter analysis unit and the actual filter unit, wherein the filter analysis unit is configured to determine loop filter parameters for the actual filter. The filter analysis unit may be configured to apply fixed pre-determined filter parameters to the actual loop filter, adaptively select filter parameters from a set of predetermined filter parameters or adaptively calculate filter parameters for the actual loop filter as will be discussed in detail below.

Embodiments of the loop filter unit 120 may comprise (not shown in FIG. 1) one or a plurality of filters, e.g. one or more of different kinds or types of filters, e.g. connected in series or in parallel or in any combination thereof, wherein each of the filters may comprise individually or jointly with other filters of the plurality of filters a filter analysis unit to determine the respective loop filter parameters, e.g. as described in the previous paragraph.

Embodiments of the encoder 100 (respectively loop filter unit 120) may be configured to output the loop filter parameters, e.g. directly or entropy encoded via the entropy encoding unit 170 or any other entropy coding unit, so that, e.g., a decoder 200 may receive and apply the same loop filter parameters for decoding.

The decoded picture buffer (DPB) 130 is configured to receive and store the filtered block 121. The decoded picture buffer 130 may be further configured to store other previously filtered blocks, e.g. previously reconstructed and filtered blocks 121, of the same current picture or of different pictures, e.g. previously reconstructed pictures, and may provide complete previously reconstructed, i.e. decoded, pictures (and corresponding reference blocks and samples) and/or a partially reconstructed current picture (and corresponding reference blocks and samples), for example for inter estimation and/or inter prediction.

Further embodiments of the invention may also be configured to use the previously filtered blocks and corresponding filtered sample values of the decoded picture buffer 130 for any kind of estimation or prediction, e.g. intra and inter estimation and prediction.

The prediction unit 160, also referred to as block prediction unit 160, is configured to receive or obtain the picture block 103 (current picture block 103 of the current picture 101) and decoded or at least reconstructed picture data, e.g. reference samples of the same (current) picture from buffer 116 and/or decoded picture data 231 from one or a plurality of previously decoded pictures from decoded picture buffer 130, and to process such data for prediction, i.e. to provide a prediction block 165, which may be an inter-predicted block 145 or an intra-predicted block 155.

Mode selection unit 162 may be configured to select a prediction mode (e.g. an intra or inter prediction mode) and/or a corresponding prediction block 145 or 155 to be used as prediction block 165 for the calculation of the residual block 105 and for the reconstruction of the reconstructed block 115.

Embodiments of the mode selection unit 162 may be configured to select the prediction mode (e.g. from those supported by prediction unit 160), which provides the best match or in other words the minimum residual (minimum residual means better compression for transmission or storage), or a minimum signaling overhead (minimum signaling overhead means better compression for transmission or storage), or which considers or balances both. The mode selection unit 162 may be configured to determine the prediction mode based on rate distortion optimization (RDO), i.e. select the prediction mode which provides a minimum rate distortion optimization or which associated rate distortion at least a fulfills a prediction mode selection criterion.

In the following the prediction processing (e.g. prediction unit 160 and mode selection (e.g. by mode selection unit 162) performed by an example encoder 100 will be explained in more detail.

As described above, encoder 100 is configured to determine or select the best or an optimum prediction mode from a set of (pre-determined) prediction modes. The set of prediction modes may comprise, e.g., intra-prediction modes and/or inter-prediction modes.

The set of intra-prediction modes may comprise 32 different intra-prediction modes, e.g. non-directional modes like DC (or mean) mode and planar mode, or directional modes, e.g. as defined in H.264, or may comprise 65 different intra-prediction modes, e.g. non-directional modes like DC (or mean) mode and planar mode, or directional modes, e.g. as defined in H.265.

The set of (or possible) inter-prediction modes depend on the available reference pictures (i.e. previous at least partially decoded pictures, e.g. stored in DBP 230) and other inter-prediction parameters, e.g. whether the whole reference picture or only a part, e.g. a search window area around the area of the current block, of the reference picture is used for searching for a best matching reference block, and/or e.g. whether pixel interpolation is applied, e.g. half/semi-pel and/or quarter-pel interpolation, or not.

Additional to the above prediction modes, skip mode and/or direct mode may be applied.

The prediction unit 160 may be further configured to partition the block 103 into smaller block partitions or sub-blocks, e.g. iteratively using quad-tree-partitioning (QT), binary partitioning (BT) or triple-tree-partitioning (TT) or any combination thereof, and to perform, e.g. the prediction for each of the block partitions or sub-blocks, wherein the mode selection comprises the selection of the tree-structure of the partitioned block 103 and the prediction modes applied to each of the block partitions or sub-blocks.

The inter estimation unit 142, also referred to as inter picture estimation unit 142, is configured to receive or obtain the picture block 103 (current picture block 103 of the current picture 101) and a decoded picture 231, or at least one or a plurality of previously reconstructed blocks, e.g. reconstructed blocks of one or a plurality of other/different previously decoded pictures 231, for inter estimation (or “inter picture estimation”). E.g. a video sequence may comprise the current picture and the previously decoded pictures 231, or in other words, the current picture and the previously decoded pictures 231 may be part of or form a sequence of pictures forming a video sequence.

The encoder 100 may, e.g., be configured to select a reference block from a plurality of reference blocks of the same or different pictures of the plurality of other pictures and provide a reference picture (or reference picture index) and/or an offset (spatial offset) between the position (x, y coordinates) of the reference block and the position of the current block as inter estimation parameters 143 to the inter prediction unit 144. This offset is also called motion vector (MV). The inter estimation is also referred to as motion estimation (ME) and the inter prediction also motion prediction (MP).

The inter prediction unit 144 is configured to obtain, e.g. receive, an inter prediction parameter 143 and to perform inter prediction based on or using the inter prediction parameter 143 to obtain an inter prediction block 145.

Although FIG. 1 shows two distinct units (or steps) for the inter-coding, namely inter estimation 142 and inter prediction 152, both functionalities may be performed as one (inter estimation requires/comprises calculating an/the inter prediction block, i.e. the or a “kind of” inter prediction 154), e.g. by testing all possible or a predetermined subset of possible inter-prediction modes iteratively while storing the currently best inter prediction mode and respective inter prediction block, and using the currently best inter prediction mode and respective inter prediction block as the (final) inter prediction parameter 143 and inter prediction block 145 without performing another time the inter prediction 144.

The intra estimation unit 152 is configured to obtain, e.g. receive, the picture block 103 (current picture block) and one or a plurality of previously reconstructed blocks, e.g. reconstructed neighbor blocks, of the same picture for intra estimation. The encoder 100 may, e.g., be configured to select an intra prediction mode from a plurality of intra prediction modes and provide it as intra estimation parameter 153 to the intra prediction unit 154.

Embodiments of the encoder 100 may be configured to select the intra-prediction mode based on an optimization criterion, e.g. minimum residual (e.g. the intra-prediction mode providing the prediction block 155 most similar to the current picture block 103) or minimum rate distortion.

The intra prediction unit 154 is configured to determine based on the intra prediction parameter 153, e.g. the selected intra prediction mode 153, the intra prediction block 155.

Although FIG. 1 shows two distinct units (or steps) for the intra-coding, namely intra estimation 152 and intra prediction 154, both functionalities may be performed as one (intra estimation comprises calculating the intra prediction block, i.e. the or a “kind of” intra prediction 154) , e.g. by testing all possible or a predetermined subset of possible intra-prediction modes iteratively while storing the currently best intra prediction mode and respective intra prediction block, and using the currently best intra prediction mode and respective intra prediction block as the (final) intra prediction parameter 153 and intra prediction block 155 without performing another time the intra prediction 154.

The entropy encoding unit 170 is configured to apply an entropy encoding algorithm or scheme (e.g. a variable length coding (VLC) scheme, an context adaptive VLC scheme (CALVC), an arithmetic coding scheme, a context adaptive binary arithmetic coding (CABAC)) on the quantized residual coefficients 109, inter prediction parameters 143, intra prediction parameter 153, and/or loop filter parameters, individually or jointly (or not at all) to obtain encoded picture data 171 which can be output by the output 172, e.g. in the form of an encoded bitstream 171.

### Decoder and Decoding Method

FIG. 2 shows an exemplary video decoder 200 configured to receive encoded picture data (e.g. encoded bitstream) 171, e.g. encoded by encoder 100, to obtain a decoded picture 231.

The decoder 200 comprises an input 202, an entropy decoding unit 204, an inverse quantization unit 210, an inverse transformation unit 212, a reconstruction unit 214, a buffer 216, a loop filter 220, a decoded picture buffer 230, a prediction unit 260, an inter prediction unit 244, an intra prediction unit 254, a mode selection unit 260 and an output 232.

The entropy decoding unit 204 is configured to perform entropy decoding to the encoded picture data 171 to obtain, e.g., quantized coefficients 209 and/or decoded coding parameters (not shown in FIG. 2), e.g. (decoded) any or all of inter prediction parameters 143, intra prediction parameter 153, and/or loop filter parameters.

In embodiments of the decoder 200, the inverse quantization unit 210, the inverse transformation unit 212, the reconstruction unit 214, the buffer 216, the loop filter 220, the decoded picture buffer 230, the prediction unit 260 and the mode selection unit 260 are configured to perform the inverse processing of the encoder 100 (and the respective functional units) to decode the encoded picture data 171.

In particular, the inverse quantization unit 210 may be identical in function to the inverse quantization unit 110, the inverse transformation unit 212 may be identical in function to the inverse transformation unit 112, the reconstruction unit 214 may be identical in function reconstruction unit 114, the buffer 216 may be identical in function to the buffer 116, the loop filter 220 may be identical in function to the loop filter 120 (with regard to the actual loop filter as the loop filter 220 typically does not comprise a filter analysis unit to determine the filter parameters based on the original image 101 or block 103 but receives (explicitly or implicitly) or obtains the filter parameters used for encoding, e.g. from entropy decoding unit 204), and the decoded picture buffer 230 may be identical in function to the decoded picture buffer 130.

The prediction unit 260 may comprise an inter prediction unit 244 and an inter prediction unit 254, wherein the inter prediction unit 144 may be identical in function to the inter prediction unit 144, and the inter prediction unit 154 may be identical in function to the intra prediction unit 154. The prediction unit 260 and the mode selection unit 262 are typically configured to perform the block prediction and/or obtain the predicted block 265 from the encoded data 171 only (without any further information about the original image 101) and to receive or obtain (explicitly or implicitly) the prediction parameters 143 or 153 and/or the information about the selected prediction mode, e.g. from the entropy decoding unit 204.

The decoder 200 is configured to output the decoded picture 230, e.g. via output 232, for presentation or viewing to a user.

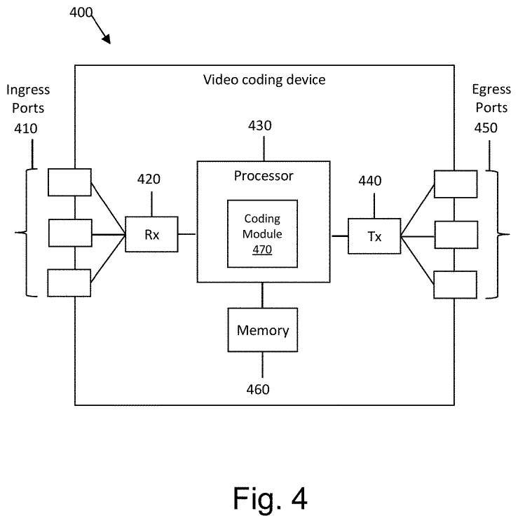

FIG. 4 is a schematic diagram of a video coding device 400 according to an embodiment of the disclosure. The video coding device 400 is suitable for implementing the disclosed embodiments as described herein for example as an encoder or decoder. The video coding device 400 comprises ingress ports 410 and receiver units (Rx) 420 for receiving data; a processor, logic unit, or central processing unit (CPU) 430 to process the data; transmitter units (Tx) 440 and egress ports 450 for transmitting the data; and a memory 460 for storing the data. The video coding device 400 may also comprise optical-to-electrical (OE) components and electrical-to-optical (EO) components coupled to the ingress ports 410, the receiver units 420, the transmitter units 440, and the egress ports 450 for egress or ingress of optical or electrical signals. The video coding device 400 may also include wireless transmitters and/or receivers in some examples.

The processor 430 is implemented by hardware and software. The processor 430 may be implemented as one or more CPU chips, cores (e.g., as a multi-core processor), field-programmable gate arrays (FPGAs), application specific integrated circuits (ASICs), and digital signal processors (DSPs). The processor 430 is in communication with the ingress ports 410, receiver units 420, transmitter units 440, egress ports 450, and memory 460. The processor 430 comprises a coding module 470. The coding module 470 implements the disclosed embodiments described above. For instance, the coding module 470 implements, processes, prepares, or provides the various coding operations. The inclusion of the coding module 470 therefore provides a substantial improvement to the functionality of the video coding device 400 and effects a transformation of the video coding device 400 to a different state. Alternatively, the coding module 470 is implemented as instructions stored in the memory 460 and executed by the processor 430.

The memory 460 comprises one or more disks, tape drives, and solid-state drives and may be used as an over-flow data storage device, to store programs when such programs are selected for execution, and to store instructions and data that are read during program execution. The memory 460 may be volatile and/or non-volatile and may be read-only memory (ROM), random access memory (RAM), ternary content-addressable memory (TCAM), and/or static random-access memory (SRAM).

Video encoding may be employed in cameras or systems with an input from one or more cameras or may run on a computer to encode/compress or transcode videos. One of the challenging applications of camera systems is video surveillance, driver assistance, autonomous driving, or computer vision driven feature coding and decoding, along with improving the compression ratio of the features.

One major task of a surveillance system is detection and identification and/or recognition of objects, including persons, motor vehicle or non-motor vehicles or the like, in a video image, respectively, in its frames using features of the video image. Such features or image features may be, for example, scale invariant feature transform SIFT, speeded up robust features SURF, and binary robust independent elementary features BRIEF. In recent years, convolutional neural network CNN-based features have become prominent as well, which may be referred to in general as machine-learning model feature, i.e. features extracted from a video image or from one frame or from some frames of the video via machine-learning models. Such models include neural networks NN, convolutional neural networks CNN, fully connected neural networks FCNN, support vector machines SVM or the like. These features are used for computer vision purposes.

Applications such as video surveillance rely on an accurate and reliable detection and identification of target objects in video images. So far, since the computing capacity at the terminal side (client) used to be limited, in present surveillance systems only the video image has been encoded at the terminal and transmitted and/or uploaded to a server in a cloud for example.

At the cloud side (server), the encoded video is decompressed (reconstructed) and image features are extracted from the reconstructed video. These features are used in computer vision algorithms to perform further analysis of the video based on these features, such as object recognition and/or identification. However, the result of such identification procedure tend to be not sufficiently accurate, since the used image features are extracted from the reconstructed video image. In other words, the source for the image features is itself error prone already, so that all image quantities derived thereof are of low quality. As a consequence, the results of the video surveillance using low quality features are less accurate. This means, for example, in case of video surveillance, that target objects are detected and/or identified with less accuracy, making the surveillance unreliable.

Thus, high quality image features from video images are needed so as to provide accurate and reliable results in computer vision applications, including video surveillance, driver assistance, autonomous driving, or computer vision driven feature coding and decoding or the like. In many cases, the image features and video are uploaded from the source (terminal), where the video and feature were taken, to an external server (e.g. in a cloud), where both may be further subject to image analysis via computer vision algorithms.

Since video image capturing devices, such as cameras, are assumed to have increasing computing resources, these devices are able to conduct in part or entirely the CV algorithms, for example, object detection or face detection, along with computing image features for the detected objects and faces. In other words, parts of the tasks of the computer vision analysis of the video is executed already at the terminal/client side. The features are extracted from the original videos at the terminal side before video compression and thus are more accurate.

Using these high quality image features, the accuracy of CV algorithms at the cloud may be improved if the high quality image features are transmitted/uploaded together with the compressed video to the cloud side (server).

As disclosed in the following exemplary embodiments of the invention, the present disclosure provides a solution to the problem how to encode image features on top of the video image at the terminal side and transmit/upload them together with the video to the cloud (server), where the video image and feature are separated and encoded separately. At the cloud side, the image features are used further in computer vision algorithms for analysis of the video using the image features.

According to an embodiment, an apparatus is provided for encoding image features on top of the video image. This is herein also referred to as hybrid video and feature (en)coding/compression. This means that the coding of the video image into a video bitstream is placed in a first layer corresponding to the base layer, and the coding of the image feature into a feature bitstream is placed in a second layer corresponding to an enhancement layer. The feature, respectively, the image feature is determined from the uncompressed, i.e. the original video. Both encoded bitstreams are combined to an output stream, containing the compressed video and coded image feature(s).

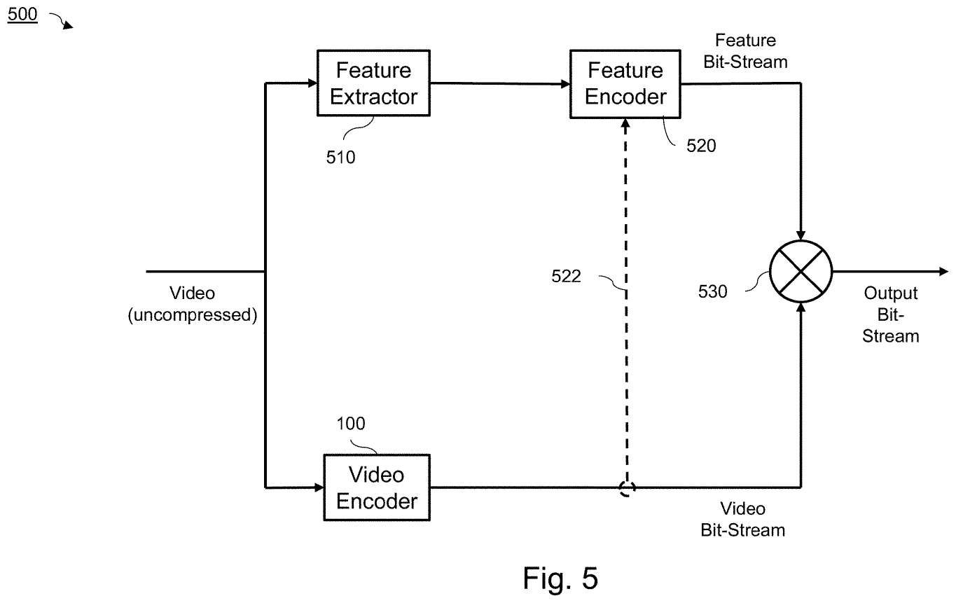

FIG. 5 shows an exemplary embodiment, e.g. apparatus, 500 of the hybrid video and feature coding for the case of independent feature encoding. This means that an image feature, extracted from an uncompressed video, is directly binarized (without predictive coding). The binarization corresponds to generating binary data to be included into the feature bitstream and may additionally include quantization of the image feature value(s). This feature encoding is performed in the enhancement layer. In the base layer, the uncompressed video image, including a plurality of video frames, is encoded, e.g. in video encoder 100, based on coding parameters to generate a video bitstream.

The encoding may be one of the known video or still image compression standards, such as AVC, HEVC, JPEG2000, or the like. In the following, the terms “video”, “video image”, “video frame”, or “frame” are used interchangeably.

Features are extracted from the original, i.e. uncompressed video by feature extractor 510.

The image feature may be extracted for a frame of the video image. Alternatively, the feature may be extracted for some or all frames of the video image, corresponding to a frame-wise, frame-based, frame-to-frame extraction of image features. The frame-wise extraction may be performed in a regular and/or irregular manner. This means that an image feature may be extracted from the uncompressed video, for example, for every fourth frame (regular order) of the video. Alternatively, the image feature may be extracted from frame 1, 2, 5, 6, 8, 9, 10 etc. corresponding to an irregular extraction. Alternatively,. The feature extraction may be performed for a certain first predetermined duration e.g. 10 ms in a regular manner followed by an irregular extraction over a second predetermined time duration e.g. 20 ms. In general, the regular and irregular feature extraction may be performed in combination with different time durations.

These features or image features may include scale invariant feature transform, SIFT, speeded up robust features, SURF, binary robust independent elementary features, BRIEF, or a feature extracted by machine-learning based models. Features extracted by a machine-learning model are referred to as network-based features. Examples of these features are provided further below. The machine-learning model may be any of a neural network NN, convolutional neural network CNN, fully connected neural network FCNN, support vector machine SVM or the like.

In the following, some of the above mentioned types of features, respectively, feature descriptors, are explained in more detail. However, the types of features are not limited to those being listed. Any other features or feature descriptors may be used in addition or alternatively depending on the application. The feature or feature descriptor can be represented by a floating point number, integer number, or binary in terms of binary symbols “0” and “1” or by a vector of floating point numbers, integer numbers or binary symbol, respectively. In general, the vector may also include elements pertaining to different types (float, integer, Boolean). Boolean values are advantageously represented by one bit, namely zero or one, representing “true” and “false”, respectively or vice versa.

SIFT features may be represented as vector of floating point numbers (real-valued feature). The calculation of SIFT features is based on the concept of “key locations/key points”, at which they are calculated. To do so, such key locations are defined (for example with reference to an image operator) and then detected. When difference of Gaussian is applied (operator), the video image is smoothed and resampled to different scales. After this image operation, key points are defined, in this case in terms of the positions of local maxima and minima.

SIFT descriptors, which are robust to local affine distortions, are then obtained by considering pixels around a radius of the key location, and at each sample of the video image a gradient orientation and magnitude is calculated. The magnitude is then weighted using a Gaussian window centered at the key point. The weight is therefore larger when the pixel is closer to the key point. The descriptor is formed from a vector, containing the values of all the orientation histogram entries. The histogram is determined based on the occurrence of all gradient orientations and magnitude of the gradient orientation.

More details on SIFT features are provided, for example, by D. G. Lowe, “Distinct Image Features from Scale-Invariant Keypoints”, accepted for publication in the International Journal of Computer Vision 2004.

In general, in case of features relying on key points, such as SIFT, BRIEF or the like, the feature includes the feature descriptor (often used synonymously with feature) and the key point. Both are determined from the video (or parts thereof e.g. one or more frames) and are encoded as image feature into the feature bitstream.

Other feature descriptors related to SIFT include histogram of oriented gradients, HOG, or speed up of robust features, SURF. These may be used alternative or in addition to those already described.

As a typical example, a 16×16 image patch is divided into 4×4 pixel arrays in a non-overlapping manner. The number of 4×4 pixel arrays is 16. In each 4×4 array, the computed gradient magnitude are accumulated into a histogram of eight orientation bins. Therefore, the SIFT feature descriptor in this example is given by a 4×4×8=128 element feature vector for each key point, with real-valued entries of each vector component.

Since SIFT features are typically vectors of 128 element floating point numbers, a vector quantizer is often used. Although vector quantization can minimize the quantization error for vectors of values, the computational complexity is considerably higher as compared to scalar quantization, where the performance improvement is limited. In addition, a vector quantizer needs to be trained using some training data, which is often infeasible in practical applications.

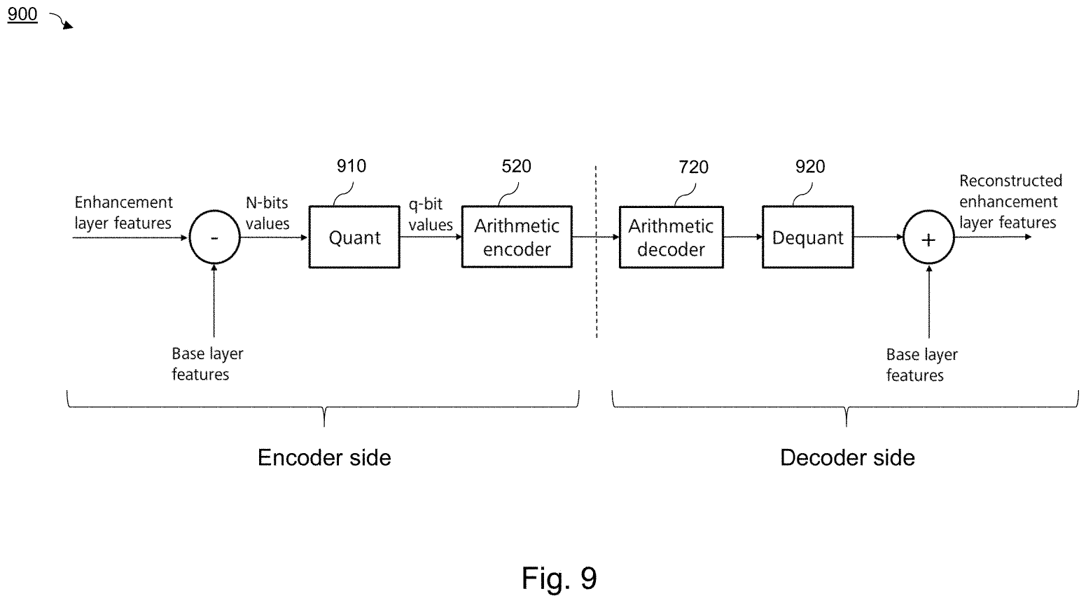

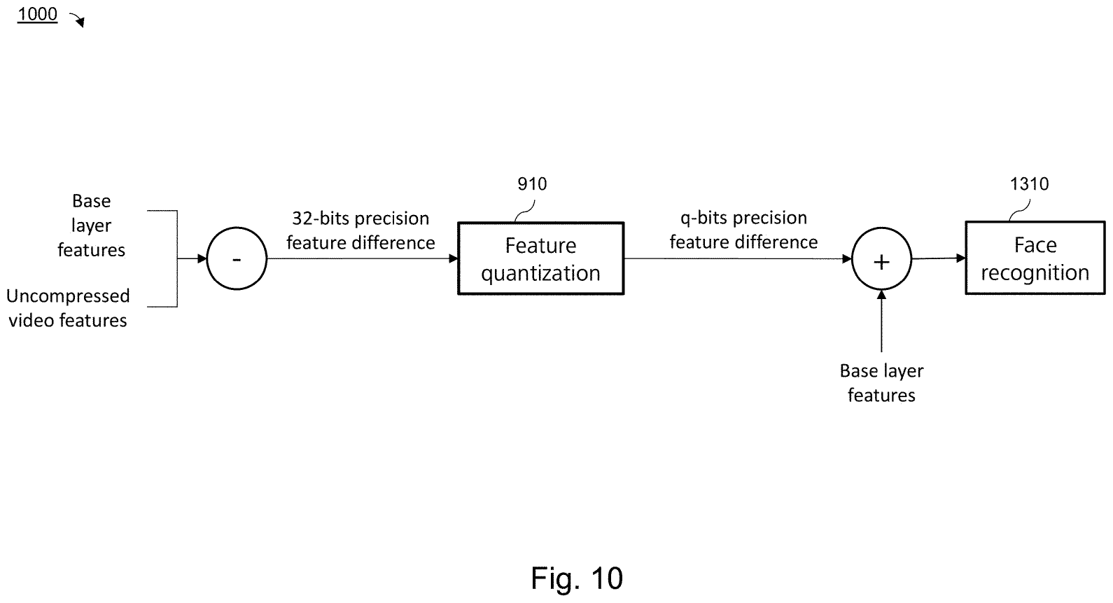

According to the present disclosure, a light-weight codec with a scalar quantizer is used, which is fully compatible with SIFT features, so that SIFT feature descriptors may be compressed without special training. The light-weight codec is explained in more detail below, with exemplary embodiments shown in FIGS. 9 and 10. In case of SIFT features, prior to encoding the floating point SIFT features are quantized.

BRIEF features are, similar to SIFT feature descriptors, determined based on key points, which are detected in either case by a key point detector. This implies that any key point detector is compatible with BRIEF features. Once a key point is detected, BRIEF feature descriptor is calculated in an image patch of a certain size around the key point. As opposed to SIFT features, BRIEF features, respectively, BRIEF feature descriptors is vector of binary values. In other words, each element value in the BRIEF feature descriptor is either 0 or 1. Hence, for a binary feature vector of size M with each of the M vector elements being binary “0” or “1”, each feature of the M binary features may be represented by one bit.

A BRIEF feature descriptors is calculated by applying first a smoothing kernel to an image patch of the video of a certain size around the key point. Then a certain sampling geometry is used to determine the position at which element values are calculated. The number of elements in a BRIEF feature could be any of 128, 256 or 512. However, the number of elements of a BRIEF feature vector may not be limited to powers of 2. The BRIEF vector may have any size in general suitable as feature descriptor in computer vision.

At each sample position, a test/filter is applied. If the result of the filer/test in positive, the value of the element of the feature vector is 0, and otherwise 1, for example. In this way, BRIEF feature descriptors are represented as vectors of binary symbols 0 or 1, with each vector component entailing whether the test (for example, by thresholding an calculated integer-valued or real-valued feature) is true or not.

Since BRIEF feature descriptors are of binary values, a quantization is not used as opposed to real-valued SIFT feature descriptors, where the real numbers still need to be quantized. In other words, BRIEF feature descriptors are directly compressed (i.e. encoded) without any prior quantization. Thus, BRIEF feature descriptors are provided directly to the encoder, such as the arithmetic codec for compression, for example, as shown in the exemplary embodiment of FIG. 10. Thus, the BRIEF feature encoding is always lossless, irrespective of whether or not BRIEF features are compressed independently or differentially. In case of differential encoding, the subtract operation between binary feature descriptors becomes a XOR operation.

CNN features, as detailed for example by Choi and Bajic, “Deep Feature Compression for Collaborative Object Detection”, arXiv: 1802.03931v1 12 Feb. 2018, refer to features extracted in general by a machine-learning model, including neural networks NN, convolutional neural networks CNN, fully connected neural networks FCNN, support vector machine SVM or the like.

In an exemplary embodiment of the present disclosure, a CNN network (such as ResNet) with 29 convolutional layers is used to generate, for example, face features for experiments on face recognition. This network model is essentially an adapted version of the ResNet-34 network of K. He, X. Zhang, S. Ren and J. Sun, “Deep Residual Learning for Image Recognition,” 2016 IEEE Conference on Computer Vision and Pattern Recognition (CVPR), Las Vegas, Nev., 2016, pp. 770-778, in which a few layers are removed and the number of filters for each layer is reduced.

The output of the CNN is a vector of 128 floating point numbers. Therefore, in this case, the CNN feature vector is very similar to a SIFT feature descriptor and thus subject to quantization prior to encoding. Other CNNs, such as AlexNet, GoogleNet, VGG, etc, can also generate feature descriptors. Moreover, many adapted version of these CNNs, for example with the input/output size changed, can also be used to generate feature descriptors.

Additionally, the output of an intermediate layer of a CNN can also be used in addition or alternatively as feature descriptors. This is often referred to as feature map, because the output of an intermediate layer is a matrix instead of a vector. In general, CNN-based feature descriptors may be given by the final output values of a CNN and/or by that of an intermediate layer.

In practice, the elements of CNN-based features used in computer vision are usually floating point numbers. Therefore, the feature CODEC shown in FIG. 9, is applicable for coding CNN-based features, where the features are subject to quantization before encoding.

However, CNN-based features may not be limited to just floating point features. Alternatively, CNN features may be also BRIEF-type features, where a CNN feature is represented binary.

Therefore, different types of CNN or machine-learning-based features may be used in computer vision application having differing representations, i.e. floating-point (SIFT-type) and/or binary (BRIEF-type). In other words, floating point and binary machine-learning-based features may be combined to perform computer vision tasks, such as face recognition of the like.

Since the image feature, including one feature or a plurality of image features, is extracted from the original, i.e. uncompressed video, the image feature in the enhancement layer is free from information loss in the video compression. In other words, the feature bitstream is lossless, resulting in a high accuracy of the image feature. These high quality features may be used (after decoding) in computer vision algorithms at the server side (e.g. cloud) to perform surveillance tasks, such as object identification by face recognition for example, at high accuracy.

The image feature is then encoded in feature encoder 520 to a feature bitstream. The encoder 520 used for the feature encoding may be an arithmetic encoder, for example, as shown by the exemplary embodiments of FIGS. 9 and 10. Alternatively, the feature encoding may be performed by a variable length coding (VLC) or any other entropy coding. The entropy coders may be context adaptive. For example, the MPEG CDVS standard feature encoder includes a vector quantizer and an entropy coder. Video encoders are also often used to compress feature maps of a CNN.

The two types of bitstreams, generated by encoding within their respective first (base) and second (enhancement) layer, are now combined into a single bitstream. This is accomplished by the multiplexer 530, which conducts multiplexing the feature bitstream and the video bitstream into an output bitstream.

The feature-video multiplexing into the output bitstream is performed such that the feature bitstream pertaining to the frame, from which the feature is extracted, is associated with the video bitstream pertaining to a video frame. In other words, even though the video and the extracted feature are separately encoded in the first and second layer, the encoded bitstreams are associated with each other with reference the frame from which the image feature is extracted. Such video-feature association may, for example, be the image feature frame index included in the feature bitstream. The timestamps of the video, respectively, of a frame may be used alternatively or additionally to synchronize the feature bitstream and the video bitstream.

The feature-video multiplexing includes further embedding the image feature into a sequence enhancement information message, SEI message, which is part of the frame header information of the video image. This means that the compressed (i.e. encoded) data of the features are included as metadata into the SEI headers of the compressed video bitstream. The metadata of a feature may include further the type of the extracted feature. In this way, both the compressed video and the compressed feature(s) are merged into a compact structure of the output bitstream, which has a rather low system complexity.

Thus, the above described video-feature association, with the feature metadata being embedded into the SEI headers of the video bitstream, enables that already the video bitstream includes information on the different features, their types, frame index and/or time stamp. This means that any of the features extracted from the uncompressed video and encoded into the feature bitstream, may be determined from the reconstructed video of the decoded video bitstream, based on the SEI header feature information.

Several implementations are possible:
The feature type of the feature to be extracted and indicated in the bitstream can be predefined, for instance in a standard. In such a case, no signaling of the feature type is necessary in the bitstream.
The feature type may be same for the entire video sequence. Thus, the feature type is signaled at the beginning of the sequence and does not need to be signaled with every frame or every feature.
There are several features transmitted within the bitstream and possibly related to the same frames. In such a case, the type of the feature can be signaled together with the feature value.

Further examples and combinations of the above implementations are possible.

The dashed line arrow 522 in FIG. 5 illustrates that the compressed video may be used by the feature encoder 520. This alternative option of feature encoding is discussed next.

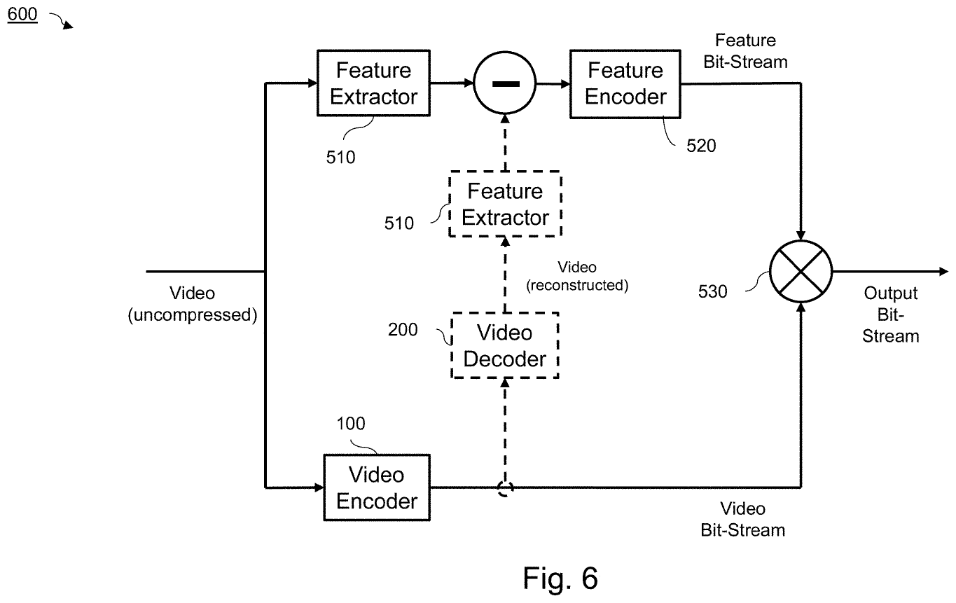

FIG. 6 shows an exemplary embodiment, e.g. apparatus, 600 of the hybrid video and feature coding, wherein an image feature extracted from the uncompressed, i.e. original video is differentially encoded.

Differential (en)coding of a feature means that extracting the feature from the reconstructed video in the base layer (first layer) and using these extracted features as predictors for coding the features in the enhancement layer (second layer). This provides the advantage of a higher coding efficiency by use of a lower bit rate. This saves bandwidth without any loss in accuracy.

As shown in FIG. 6, differential encoding comprises decoding at the terminal side the compressed video bitstream by the video decoder 200 (e.g. by the built-in decoder part of the encoder 100) to obtain a reconstructed video. This is followed by feature extractor 510, which extracts the image feature from the reconstructed video. As result, this image feature is lossy, i.e. it is error prone as the reconstructed video is already lossy. The extracted image feature is then subtracted from the image feature extracted from the original video, resulting in a differential image feature.

As in case of independent feature coding, the differential image feature is encoded by feature encoder 520 into a feature bitstream of the differential image feature, which is then multiplexed 530 with the video bitstream into the output bitstream. The multiplexing in the differential encoding includes also embedding the image feature into a sequence enhancement information message, SEI message, which is part of the frame header information of the video image. This means that the compressed (i.e. encoded) data of the features are included as metadata into the SEI headers of the compressed video bitstream. In this way, both the compressed video and the compressed feature(s) are merged into a compact structure of the output bitstream, which provides a low system complexity and reduced bit rate.

In other words, embodiments of the present invention may enable both image feature encoding and differential feature encoding, which is signaled by a mode (m) including one bit. This is explained below when discussing the syntax of the metadata container to include image features.

While the output bitstream contains both feature bitstream and video bitstream, in many cases the features in the enhancement layer are sufficient for the target CV algorithms, which are designed for specific features. However, the video in the base layer may still be used in order to calculate other types of features later on for a broader range of CV algorithms.

Moreover, in the area of video surveillance, the interesting parts of the videos, for example, a video clip, in which the face of a target person is recognized, are be provided to humans to double check the correctness of the results provided by the CV algorithm. Noteworthy, only image and videos may be presented as evidence in court, but not the features. Therefore, the video is transmitted too and in general stored in a server. Interesting parts of the videos may then be retrieved using the image features.

The generated output bitstream may then be processed further, and uploaded from the terminal side to a server of a cloud, for example. The upload may be performed by any delivery method, including wired or wireless communication (data broadcast), network or the like.

The cloud side may include a CV image analysis system, to which the uploaded output bitstream is provided as input bitstream.

According to an embodiment, an apparatus is provided for reconstructing a video from an input bitstream, which includes a feature bitstream and a video bitstream. This is herein also referred to as hybrid video and feature decoding/decompression. This means that the input bitstream is separated into its components feature bitstream and video bitstream, and both streams are decoded in order to obtain a reconstructed video and the uncompressed image feature.

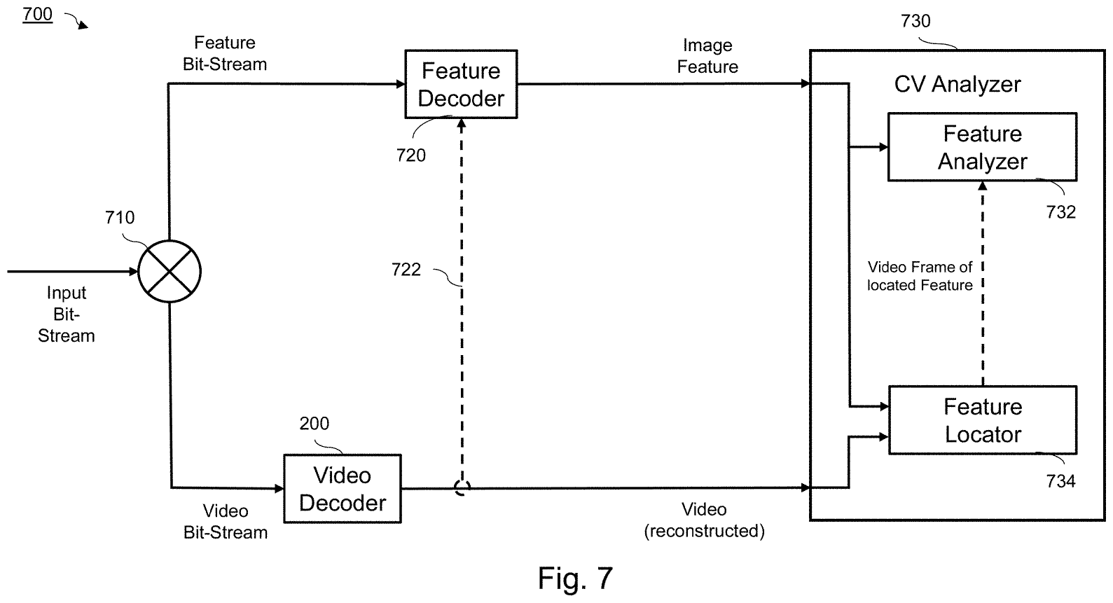

FIG. 7 shows an exemplary embodiment, e.g. apparatus, 700 of the hybrid video and feature decoding, where a video bitstream is uncompressed or decoded by video decoder 200, providing a reconstructed video.

The decoding may be one of the known video or still image compression standards, such as AVC, HEVC, JPEG2000, or the like.

The input bitstream, which includes the video bitstream and the feature bitstream, is generated by the apparatus for hybrid video and feature coding providing as output an output bitstream, as described by the previous embodiments of the present disclosure with reference to FIGS. 5 and 6.

In other words, the input bitstream, which is provided to the apparatus for reconstructing the video, is the output bitstream provided by the apparatus for hybrid video and feature encoding. Therefore, the input bitstream has the same features as the output bitstream. Part of these feature will be repeated below for completeness. For the other features, we refer to the discussion of the previous embodiments of the present disclosure with reference to FIGS. 5 and 6.

Before the video decoding, the input bitstream is de-multiplexed by demultiplexer 710 into a video bitstream and a feature bitstream.

According to the present disclosure, since input bitstream and output bitstream are the same, the input bitstream contains the feature bitstream and the video bitstream in a multiplexing manner. This means that the video bitstream and feature bitstream of the input bitstream are associated with each other through the frame of the video, from which the image feature were extracted at the terminal side.

Yet, video bitstream and feature bitstream still belong to different layers, with the video bitstream being in the base layer (first layer) and the feature bitstream in the enhancement layer (second layer). Such association may, for example, be the image feature frame index included in the feature bitstream. The de-multiplexing is thus performed with reference to the frame used (at the terminal side) from which an image feature is extracted.

The image feature is then decoded from the feature bitstream by feature decoder 720.

The image feature, which is included in the input bitstream through the feature bitstream, is inserted (via multiplexing) in a sequence enhancement information SEI message belonging to frame header information of the video. This means that the compressed (i.e. encoded) data of the features are included as metadata into the SEI headers of the compressed video bitstream. The image feature may be thus obtained from the input bitstream by de-multiplexing the SEI message.

The decoded image feature is for a frame of the video. This is a result of the frame-based association between the video bitstream and the feature bitstream. Alternatively, the image feature may be for some or all frames of the video. This implies that the frame association between the video and the features may be regular and/or irregular. This means that the original extraction of image features from the video was performed in a regular and/or irregular manner, for example, for every fourth frame (regular order) of the video. Alternatively, the image feature may have been extracted from frame 1, 2, 5, 6, 8, 9, 10 etc. corresponding to an irregular order pf extraction. The feature extraction may have been also performed for a certain first predetermined duration of e.g. 10 ms in a regular manner, followed by an irregular extraction over a second predetermined time duration of e.g. 20 ms. In general, the regular and irregular feature extraction may have been performed in any order in combination with different time durations. This translates directly into a regular and/or irregular association of the video bitstream and feature bitstream of the input bitstream.

With both bitstreams (video and feature) being decoded, the image feature may now be located in the video.

In the exemplary embodiment shown in FIG. 7, the locating of an image feature (e.g. locating the image patch related to the image feature) is performed by feature locator 734 (e.g. based on the decoded features, e.g. comprising also the location of the feature), which may be part of a computer vision CV analyzer 730 performing analysis of image features by a feature analyzer 732.

Locating one feature or a plurality of image features may include, for example, accessing the frame of the video containing one or a plurality of image features. Alternatively, more than one frame may be accessed. Since one feature or multiple features are associated with the video via the frame or frames, from which the feature or multiple features has/have been extracted, any feature may be located in the reconstructed video by the frame-based feature-video association.

In addition or alternatively, feature locating may include retrieval of the video, which may be stored on a storage device or the like, for example. This means to retrieve only those parts of the video (i.e. one frame or multiple frames), which contain sought image features.

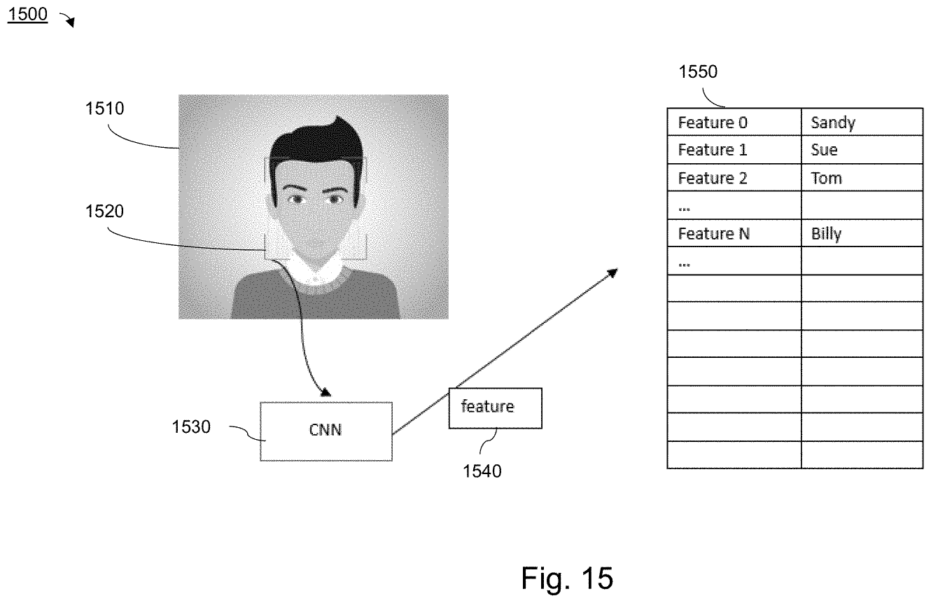

This may be illustrated further by the example of a face recognition embodiment 1500 shown in FIG. 15, in case of a CNN feature for face recognition. An image patch 1520 of a face is cropped from the uncompressed video (here of a video frame 1510) already at the terminal. The image patch 1520 may be forwarded to a CNN 1530 for example, which classifies the patch and provides a feature (e.g. a feature vector) 1540 as output. This feature is then compared with pre-determined features “0, “1”, “2”, etc. of known target faces, which have been pre-computer with the same CNN. By comparing the determined feature with the pre-determined ones (e.g. stored in a database table 1550), a person may be identified based on the feature from an image patch cropped from the original (i.e. uncompressed) video.

The classification of the image patch by the CNN may be performed already at the terminal side, at which the extracted feature may be encoded into the feature bitstream. At the cloud side, after the video-feature bitstream de-multiplexing, the feature is encoded from the feature bitstream and compared with the known features of the database. In other words, a face recognition may be performed entirely already at the terminal side or, optionally, in a distributed manner. This means that parts of the tasks related to face recognition may be performed at the terminal side (e.g. cropping of an image patch and CNN-based feature extraction) and other parts at the cloud side (e.g. feature comparison with databased features).

However, the face recognition may use one or more additional features, which may have not been extracted from the image patch by the CNN at the terminal side, in order to make the recognition more accurate. In this case, these additional features may be extracted by the CNN from the video frame at the cloud side. This means that the CNN may also use the actual part of the video (e.g. the respective frame) from which the first feature was prior extracted at the terminal side. Thus, this feature is located in the video bitstream, respectively, in the video. This is realized by the frame-based video-feature association. Therefore, only the part of the video bitstream is retrieved and decoded into the video frame, which contains the first feature. This video frame may then be further used by and forwarded to the CNN and/or other parts of the CV analyzer in order to determine the additional kinds of features needed for face recognition.

In addition or alternatively, image locating may include rendering of the video. This means to show and/or display only those parts of the video (i.e. one frame or multiple frames), which contain sought image features. In addition, the video frames may be shown with the respective image features overlaid or marked/labeled in the frames. Alternatively, one or more feature-rendered frames may be shown together with other frames of the video, which do not contain those image features.

In the example of FIG. 7, the video frame, in which the image feature is located, is then provided as input to feature analyzer 732, where the frame may be further analyzed. For example, this includes identification of a person (i.e. face recognition) based on the image feature “face”. The analysis may include in addition or alternatively determining from one frame or multiple frames one or more features, which are different from the image feature(s) used to locate the one or multiple frames.

In general, the image feature may be any of scale invariant feature transform, SIFT, speeded up robust feature, SURF, binary robust independent elementary feature, BRIEF, or a feature extracted by machine-learning based models.

The features are not limited to those listed and any other types of image features may be used in addition or alternatively, depending on the application. In case of video surveillance, SIFT, SURF, BRIEF, and CNN features are often used. How these types of features are defined and determined has been explained further above with reference to the embodiments of the apparatus for hybrid video and feature coding.

As mentioned before, the input bitstream of the hybrid video and feature decoder is the same as the output bitstream of the hybrid video and feature encoder. Thus, input bitstream and output bitstream contain the same image feature.

The dashed line arrow 722 in FIG. 7 illustrates that the reconstructed video may be used by the feature decoder 720. This alternative option of feature decoding is discussed next.

FIG. 8 shows an exemplary embodiment, e.g. apparatus, 800 of the hybrid video and feature decoding, which includes reconstructing the video and an image feature, extracted from the reconstructed video, that is used to determine the image feature of the video. This refers to differential feature decoding.

Differential decoding of a feature means that an image feature is extracted from the reconstructed video in the base layer (first layer), which is then used as predictors for encoding the feature in the enhancement layer (second layer). This provides the advantage of a higher decoding efficiency by use of a lower bit rate. This saves bandwidth without any loss in accuracy.

Thus, in differential decoding both the base layer (video) and enhancement layer (feature) interact in order to obtain the image feature of the video. It implies further that the image feature included in the feature bitstream of the input bitstream is a differential image feature. Differential decoding is therefore the antagonist of differential encoding, where a differential image feature is generated and included into a feature bitstream of an output bitstream, as provided by a hybrid video and feature encoder.

How this is accomplished, has been explained in the exemplary embodiment of the present invention with reference to FIG. 6.

In short, a differential image feature is generated (at the terminal side, i.e. encoder) by subtracting the feature, extracted from the reconstructed video, from the feature extracted from the uncompressed, i.e. original video. For the same feature, the feature value is expected to be different, since the reconstructed video is lossy. Thus, the corresponding image feature is lossy as opposed to the lossless feature extracted from the original video.

The goal is therefore to determine at the server side (i.e. decoder) the image feature from the differential feature and the feature extracted from the reconstructed video.

As shown in FIG. 8, differential decoding requires extract the feature by feature extractor 510 from the reconstructed video, which is prior determined by encoding the video bitstream by video decoder 200. As mentioned before, the extracted image feature is lossy, i.e. it is error prone as the reconstructed video is already lossy.

As in case of independent feature decoding shown in the embodiment of FIG. 7, feature decoder 720 uncompresses the feature bitstream, with the feature now being a differential image feature. The differential feature is then added to the image feature extracted from the reconstructed video, and the near-lossless image feature of the video is obtained.

In other words, the disclosure of the present invention with reference to FIGS. 7 and 8 enables decoding of an image feature and differential image feature. In which mode (m) (independent or differential) the decoder has to decode the feature bitstream is signaled (via one bit) to the decoder through the input bitstream, respectively, the output bitstream of the encoder. This information of mode (m) is included into the metadata, which is part of the SEI message belonging to the frame header information of the video.

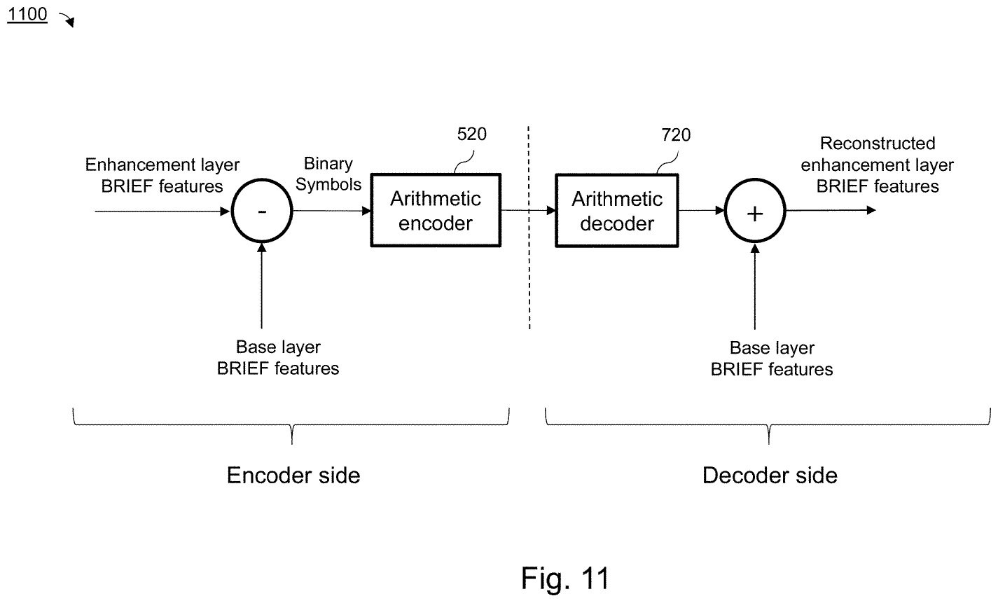

This is explained in the embodiment of the present disclosure referring to FIG. 11, when discussing the syntax of the metadata container to include image features into the video bitstream.

With both bitstreams (video and feature) being decoded, the image feature may now be located in the video by feature locator 734, as in the case of the independent feature decoding of the previous embodiment. With reference to the independent decoding shown in FIG. 7, a further analysis of the reconstructed video by be performed, for example, by CV analyzer 730. This analyzer may perform face recognition for example, where the image feature may be further analyzed by feature analyzer 732. This includes locating the image feature (or a plurality thereof) in one frame or a plurality of frames of the reconstructed video through the frame-based feature-video association. The frames are provided to the feature analyzer 732, which may further process the video frames based on the image features and/or may determine in addition or alternatively other image features different from those image features of the feature bitstream.

In the previous embodiments discussed with reference to FIGS. 5 to 8, one feature or a plurality of image features are encoded either independently or differentially, irrespective of the type of the feature extracted from the uncompressed, i.e. original video. Examples of image features suitable for computer vision have been introduced and explained, including SIFT features, BRIEF features and CNN features.

In one exemplary embodiment of the present disclosure, the feature encoding and decoding is performed by an arithmetic encoder/decoder, as shown in FIGS. 9 and 11. Alternatively, variable length coding VLC and/or entropy encoding may be used.

Prior to feature encoding, an image feature may be subject to quantization and depends on whether or the feature is a vector represented as floating point (e.g. SIFT, CNN etc.) or binary (BRIEF etc.). In particular, when image features are floating point, vector quantization of the feature vector is used to achieve an optimal performance of the SIFT feature compression. However, vector quantization needs to be trained based on some training data. In case of CNN features, there are hundreds of different CNN types and variations, and if a vector quantizer is used for compression, the vector quantizer needs retraining when switching from one CNN to another. This limits the feasibility of vector quantizers in practice.

As discussed in the following embodiments of the present disclosure with reference to FIG. 9, a light-weight feature codec is introduced corresponding to a scalar quantizer, which does not need any training or retraining. As will be detailed further below, in the scalar light-weight feature codec only the parameter q needs to be determined or adapted for each different type of floating point CNN feature. Thus, the scalar quantizer has a low system complexity and is thus feasible in particular for floating point machine-learning model features, such as CNN features.

FIG. 9 shows an exemplary embodiment, e.g. a system comprising an encoder and a decoder, 900 of the light-weight feature codec. In the example of FIGS. 9 and 10, a floating point image feature is encoded differentially. Alternatively, the feature may be quantized and encoded independently, following the same processing or procedure as detailed below. In the following, the term feature refers to either an image feature (independent encoding) or an differential feature (differential encoding).

The floating point input feature is assumed to be a vector of N-bits values, which is typically 32-bit or 64-bit floating point numbers, depending on the computing architecture. The N-bits floating point values are then quantized to q-bits fixed point values with q<N by quantizer 910. In the example of FIG. 9, the q bits include 1 sign bit, qi bits to represent the integer part, and of bits for the fractional part. Therefore, the q-bits may be written as q=1+qi+qf.

After the qi−qf division of the q-bits, the q-bits values are converted to binary strings and encoded using an arithmetic encoder 520. The quantization is performed using the following exemplary pseudo code, with x being the input N-bits floating point value:

### Encoder:

int y=(int)((x)*(1<<(N−qi−1)))

take the most significant q bits (including the sign bit) and truncate the remaining N−q bits.

At the server side, inverse operations including arithmetic decoding 720 and de-quantization 920 are performed, and the enhancement layer features are reconstructed, exemplified by the pseudo code, with x r being the reconstructed N-bits floating point value:

### Decoder:

take the q bits value, append N−q zero digits and convert it to an integer y

float x_r=((float)(y))/(1<<(N−qi−1))

The above binary shift operators (left shift) may be understood further by the following example, assuming x=0.3, N=32 bits, q=16 (binary 1000), qi=7 (binary 0111), and qf=8 (binary 1000).

### Encoder:

### Step 1: 0.3 * (1<<(32-7-1))=0.3*(2\hat{ }24)=5033164.8

Step 2: convert the number to integer→5033164
Step 3: convert the number to binary string of N bits: 00000000 01001100 11001100 11001100
Step 4: take the most significant q bits: 00000000 01001100

### Decoder:

Step 1: get the q bit value and add 0 behind: 00000000 01001100 00000000 00000000
Step 2: convert the binary string to decimal number: 4980736
Step 3: convert the number to float point: 4980736.0

### Step 4: 4980736.0/(1<<(32-7-1))=4980736.0/2\hat{ }24=0.296875

This example shows that a floating point feature value of x=0.3 (represented by N=32 bits) may be represented by much lower q-bits after the N−q quantization, while retaining a high accuracy of the image feature value (0.3 vs. 0.296875 corresponding to a 1% error while reducing the number of bits by two).

Integer numbers may be both signed or unsigned, in which case qf=0 and q=1+qi (signed), respectively, qf=0 and q=qi (unsigned).

The quantization of signed and unsigned integers is then performed as follows:

### Encoder:

Step 1: take the most significant q bits
Step 2: truncate the remaining N−q bits.

### Decoder:

Step 1: take the q bits value and append N−q zero digits
Step 2: convert binary number to integer y.

In case of binary features like BRIEF, each element value is binary, and is treated as an unsigned integer of one bit. Hence, a binary element value may be encoded and decoded by the light-weight CODEC setting qf=0 and q=qi=1. The quantization of binary feature values is then performed in the same manner as in case of unsigned integers.

FIG. 10 illustrates an embodiment, e.g. an encoder, 1000 for the above example of an original N=32 bit differential image feature (e.g. a face) the feature quantization 910 toward a lower number of q bits of the same differential feature, which after reconstruction of the original feature is used for face recognition 1310.

The arithmetic encoder and decoder are conventional ones and they are lossless.

In practice, it is recommended to set the bit depth parameter q to half of the original bit depth. For example, for N=32 bit features q is set to 16 bits, including 1 bit for sign, 7 bits for the integer part and 8 bits for the fractional part. Likewise, for N=32 bit features q is set to 32 bits, including 1 bit for sign, 15 bits for the integer part and 16 bits for the fractional part.

The setting are not limited to the above values. Of course, the parameters q, qi, and qf can also be set to different values or determined adaptively, based on the input features. In the latter case, these parameters are signaled to the decoder side.

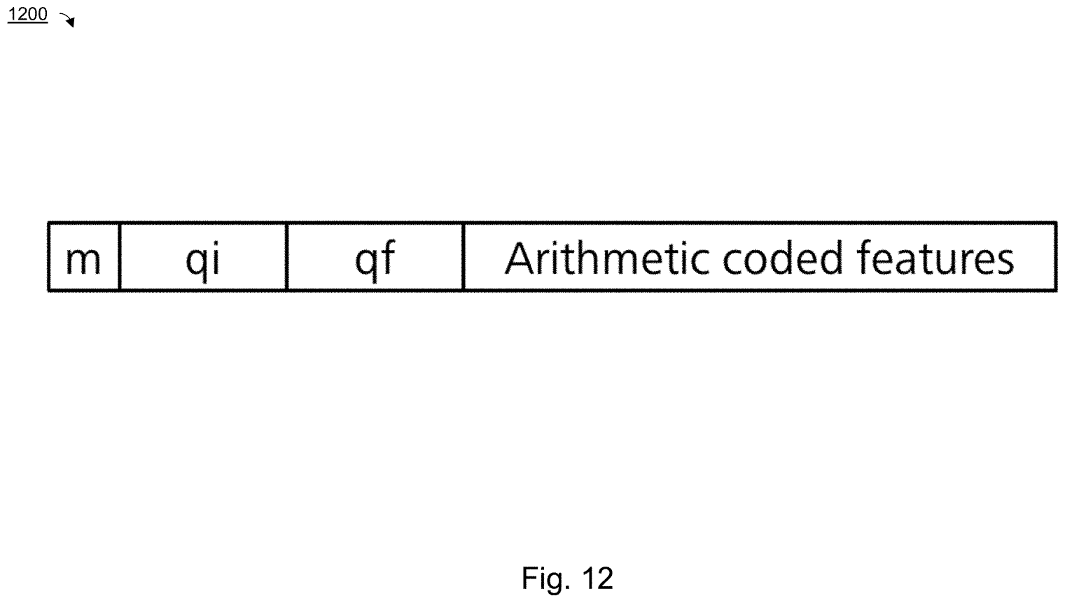

FIG. 11 shows an additional exemplary embodiment, e.g. a system comprising an encoder and a decoder, 1100 of the feature codec, to which the light-weight feature codec is applicable, as becoming clear when discussing below the syntax of the feature metadata shown in FIG. 12. Similar to the embodiment shown in FIG. 9, the one of FIG. 11 refers to the exemplary case where the image feature is a differential image feature. Instead, the feature may be the image feature encoded independently, i.e. without the need of image features extracted from the reconstructed video of the base layer.

In the example of FIG. 11, the N-bit image feature is provided directly to the arithmetic encoder 520 at the terminal side, which is then also directly decoded 720 at the cloud without quantization and dequantization. Thus, the image feature refers to a binary image feature, such as BRIEF, which has been explained in detail above.

Now that the video and image feature are encodes in their respective layers, with the image features being quantized via the light-weight codec, the information related to the encoded features are packed into a suitable format compatible with the encoded video bitstream. As explained before, the feature bitstream is combined with the video bitstream (video-feature multiplex) into an output bitstream by including the image feature as metadata into the SEI header of the video bitstream.

FIG. 12 shows an exemplary embodiment of the syntax of the metadata container 1200, which allows to include an image feature, encoded by the light-weight encoder, as metadata into the SEI header of the video bitstream.

One bit is used to signal the coding mode (m) whether direct coding or differential coding is conducted. Further, one to four bits are used to signal the bit depth for the integer part (qi) of the feature values, and another two to four bits to signal the bit depth of the fractional part (qf) of the feature values.

With these parameters {m,qi,qf}, the decoder can correctly interpret the decoded fixed point feature values and reconstruct the floating point values. Of course, other image feature information, such as size of the features, number of features, and locations of features in the video or frame may also be used. This information may be added in addition to the metadata container. The metadata may include an additional parameter to indicate the type of the feature. Further embodiments of the syntax of the metadata container may not use (not comprise) coding mode (m), e.g. in case the mode is predetermined or does not change (i.e. is fixed), e.g. for a whole sequence of video pictures, a whole video or in general, e.g. by system configuration.

This syntax of the metadata container allows to manage also non-floating point features, such as binary feature vectors as in case of BRIEF features. Since both floating-point features and binary features may be encoded independently or differentially, the mode-bit m is set in either case. For example, m may be set to zero (m=0) to signal independent encoding, respectively, to m=1 for differential encoding, or vice versa. As to the integer and fractional bit depths qi and qf, since BRIEF features are already binary, the bit depth qf is a dummy variable. Thus, in case of binary features, qf is set to zero. Further, since the value of a binary feature may be binary “0” or “1”, the number of bits N to represent one binary feature is N=1. Hence, for a binary feature vector of size M (i.e. there are M elements with a binary value) for example, the respective metadata for each of the M binary feature elements is {m,1,0} With these settings, the light-weight feature CODEC can handle also binary feature vectors.

When more than one feature are extracted from a video frame, all extracted image features are put together into a single metadata container, which is added to the SEI header of the video frame in the video bitstream, for example, a H264 or H265 standard video stream or a newer video coding standard. In this manner, the features in the enhancement layer are synchronized with the video stream. In other words, the feature bitstream pertaining to a frame and the video bitstream pertaining to a frame are associated.

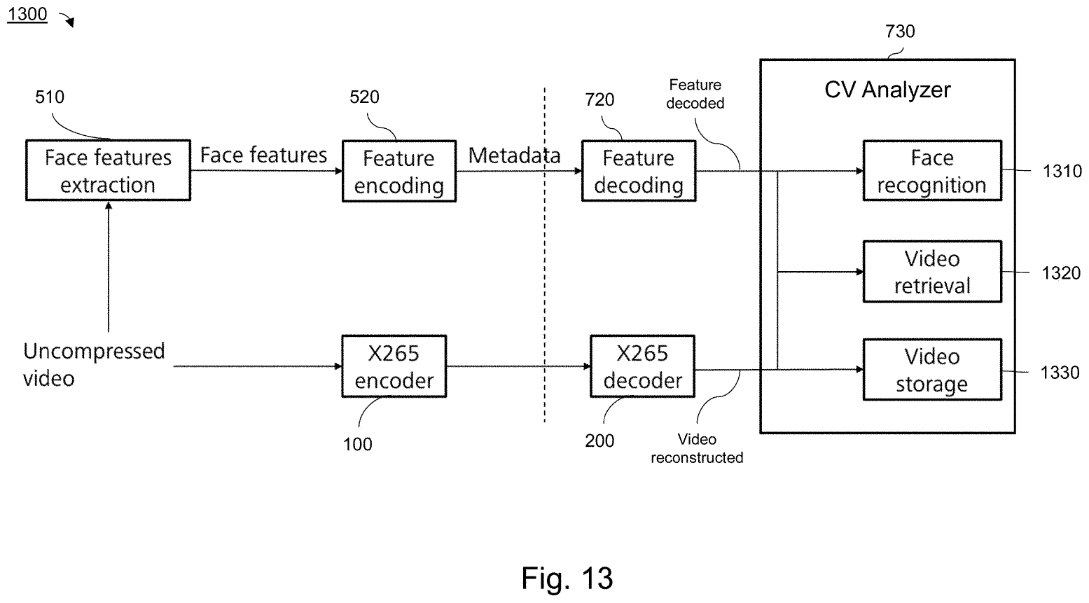

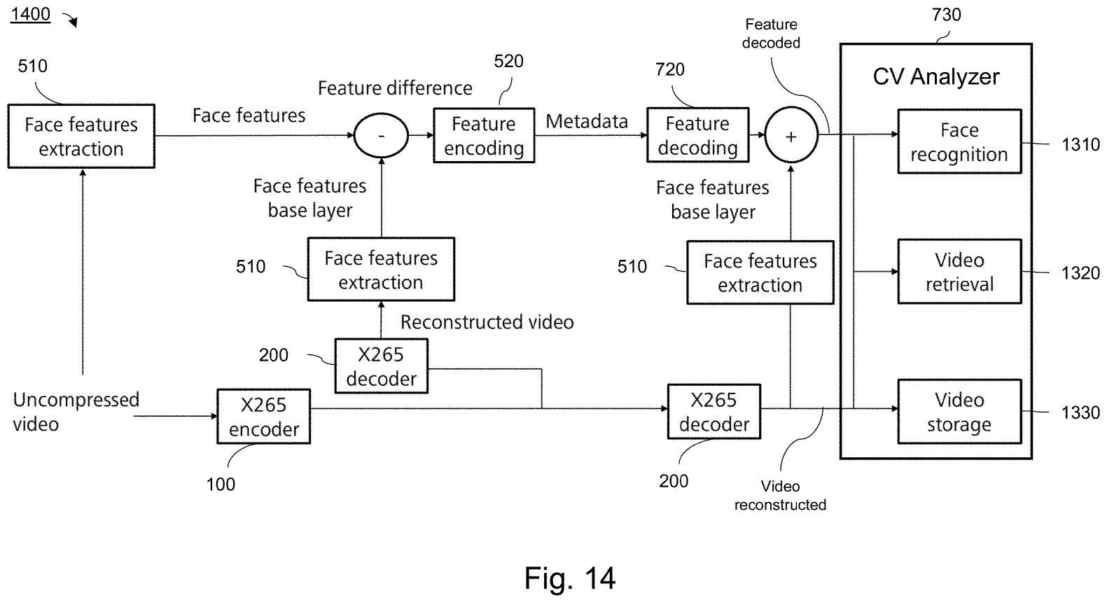

The following exemplary embodiments show a computer vision system, in which the hybrid video and feature encoder and decoder are combined into one system. The computer vision (CV) system 1300, comprising an encoding and a decoding part, of FIG. 13 shows the system for the case where the feature is coded and decoded independently of the video. FIG. 14 shows an embodiment of the CV system 1400, comprising an encoding part and a decoding part, with the feature being differentially encoded and decoded, thus requiring feature extraction from the reconstructed video at the terminal side (client) and for decoding at the server side (cloud).

FIG. 13 shows an exemplary embodiment of the present disclosure, wherein the encoder and decoder of the embodiments of FIGS. 5 and 7 are combined into one system. The video is coded in the base layer by a standard encoder, e.g. according to H.265 (e.g. by open-source X265 encoder), (video encoder 100), and features are coded in the enhancement layer independently from the video in the base layer by the feature encoder 520, for example, via arithmetic encoding. The image feature may be a face features, which is extracted from the uncompressed video stream by a face feature extractor 510. The coded feature bitstream is taken as metadata for the video bitstream and encapsulated in the SEI headers in the video bitstream.

At the server side, the video is decoded (i.e. reconstructed) in the base layer by a standard decoder, e.g. according to H.265 (e.g. by open-source X265 decoder), (video decoder 200) for example, and the feature bit stream is taken out from the video SEI headers and decoded by feature decoder 720 independently from the reconstructed video. The decoded features (for example a face feature) in the enhancement layer are used for some target CV algorithms executed by the CV analyzer 730, which may include face recognition 1310.

In this exemplary embodiment of the present disclosure, the location of the image feature by feature locator 734 includes a video retrieval 1320 from the video storage 1330 containing the stored reconstructed video, using the features in the enhancement layer as well as the video in the base layer. Hereby, video retrieval refers to a process of identifying and extracting a part or a plurality of parts of the reconstructed video, which contains some of the specific features, for example, the face of some target person. Since the image features are extracted frame-wise and associated with the respective frame of the video, a feature or a plurality of image features of the decoded feature bitstream may be identified within the reconstructed video based on the frame index, for example.

In the embodiment shown in FIG. 13, the coding of an image feature is performed independently in the enhancement layer, without the need for video reconstruction and feature extraction from the reconstructed video at the terminal. Since the (near-lossless) image feature is already encoded into the feature bitstream, the complexity of the decoding at the server side is reduced, because a further feature extraction at the server side is not needed.

Therefore at the server side, after the input bitstream is de-multiplexed into the video bitstream and feature bitstream, the video bitstream need to be decoded only if some features indicate that there are some interesting parts of the video, for example, a target person shows up or a car exceeds the speed limit. This means that at the first stage of, for example, a CV-based video surveillance only the features may be needed in order to check whether a target subject or object is recognized. The video itself is not needed at this stage. Only when a target object is recognized, only the part of the video containing the respective feature is encoded. In other words, the video is accessed and/or retrieved only if needed based on the (independently encoded) image feature. Given that most parts of a surveillance video are uninteresting (corresponding to no existing target features in the video), in most instances during the surveillance there is no need to decode the video. Therefore, the decoding complexity at the cloud (server) can be highly reduced.

FIG. 14 shows an exemplary embodiment of the present disclosure, wherein the encoder and decoder of the embodiments of FIGS. 6 and 8 are combined into one system. The only difference of this embodiment to the previous one shown in FIG. 13 is that features are encoded and decoded differentially, and is performed by the same feature codec. In general, the feature codec is configured to perform both independent and differential feature coding and decoding.

In the embodiment of FIG. 14, the codec is used to code the difference between the features extracted from the uncompressed video (face feature extractor 510) and those extracted from the reconstructed video in the base layer (X265 decoder 200 and face feature extractor 510). The bitstream of the coded feature difference (feature encoding 520) is taken as metadata and encapsulated in the SEI headers of the video stream. At the server side, the feature difference is decoded (feature decoding 720) and added to the features extracted from the reconstructed video in the base layer (X265 decoder 200 and face feature extractor 510), so that the enhancement features are reconstructed.

The decoded image features and the reconstructed video may then be used in a similar or same manner as described before with regard to the embodiment shown in FIG. 13, including the CV analyzer 730 performing face recognition 1310 after a part (one frame) or parts (some frames) of the reconstructed video have been retrieved by video retrieval 1320 from the reconstructed video stored in video storage 1330, based on the image features.

Compared to the embodiment shown in FIG. 13 (independent feature (de)coding), the advantage of the embodiment of FIG. 14 is a significantly higher coding efficiency of the features in the enhancement layer as a result of the predictive feature coding, which is conducted based on the features extracted from the base layer video.

According to an embodiment, a method is provided for encoding a video comprising the steps of encoding the video into a video bitstream, extracting an image feature from the video, encoding the image feature into a feature bitstream, and multiplexing the feature bitstream and the video bitstream into an output bitstream.

According to an embodiment, a method is provided for reconstructing a video comprising the steps of de-multiplexing from an input bitstream a video bit-stream and a feature bit-stream, decoding from the video bitstream the video, decoding from the feature bitstream an image feature of the video; and locating the image feature in the video.

According to an embodiment, a computer-readable non-transitory medium stores a program, including instructions which when executed on a processor cause the processor to perform the steps of the method for encoding a video and/or reconstructing the video.

The program may be one program which executes the instructions for encoding and reconstructing the video sequentially. Alternatively, the program may include a first program for encoding the video and second program different from the first program for reconstructing the video.

The embodiments of the invention enable to perform computer vision analysis via computer vision algorithms more accurately and reliably, as result of using high-quality image features. These image features are determined at the terminal side, where the video is taken by a camera and the image feature is extracted from the uncompressed (i.e. undistorted) video. Thus, the extracted feature is lossless, rather than being extracted from a lossy reconstructed video as commonly performed. Therefore, typical computer visions tasks, such as face detection and face recognition may be performed with high accuracy.

For such computer vision tasks it is important that one or a plurality of image features are of high quality, in order to achieve a high precision in applications such as video surveillance, computer vision feature coding, or autonomous driving, for example.

At the same time, it is important that the extracted high quality image features are encoded (compressed) efficiently to assure a fast encoding of the features into the feature bitstream and its multiplexing with the video bitstream into the final output bitstream.

This is accomplished by embodiments of the light-weight encoder of the present invention, which is a scalar quantizer and thus does not need any pre-training or re-training as in case of a vector quantizer. In this case, N-bit floating point features are quantized by q-bits with q typically being half of the original bit depth. This largely reduces the bit rate, so that the light-weight quantizer provides an improved compression ratio of encoded features along with preserved bandwith, without loss of image feature quality.

The approach disclosed by the embodiments of the invention may be used and implemented on chips, in surveillance cameras, or other consumer devices with computer vision algorithms based on camera.

Summarizing, the present disclosure relates to hybrid video and feature encoding and decoding, with the encoding and decoding of the image feature being performed independently or differentially. The video and feature are encoded and decoded in separate base layer and enhancement layer. The feature is extracted for a frame of the video, providing a frame-based feature-video association. A feature is extracted from an uncompressed video encoded in an enhancement layer into a feature bitstream. The video is encoded into a video bitstream, with the feature bitstream being embedded into the video bitstream by multiplexing both streams into an output bitstream. The image feature, which may be a differential image feature, is included in a sequence enhancement information SEI message of a frame header information of the video. The output bitstream is provided as input bitstream to a decoder, which de-multiplexes the input bitstream into a video bitstream and feature bitstream, using the SEI message of the frame header. Both bitstreams are decoded in their respective layers, and the image feature is located in the video using the frame-based feature-video association.

Note that this specification provides explanations for pictures (frames), but fields substitute as pictures in the case of an interlace picture signal.

Although embodiments of the invention have been primarily described based on video coding, it should be noted that any embodiment as specified in the claims and described in this application not using inter-picture prediction is or may also be configured for still picture feature extraction and still picture processing or coding, i.e. for feature extraction and for the processing or coding based on an individual picture independent of any preceding or consecutive picture(s) as in video coding. The disclosure provided herein with regard to video picture embodiments applies equally to those still picture embodiments. The only difference compared to video feature extraction and video coding is that no inter-picture prediction is used for coding.

The person skilled in the art will understand that the “blocks” (“units”) of the various figures (method and apparatus) represent or describe functionalities of embodiments of the invention (rather than necessarily individual “units” in hardware or software) and thus describe equally functions or features of apparatus embodiments as well as method embodiments (unit=step).

The terminology of “units” is merely used for illustrative purposes of the functionality of embodiments of the encoder/decoder and are not intended to limiting the disclosure.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, the functional units in the embodiments of the invention may be integrated into one processing unit, or each of the units may exist alone physically, or two or more units are integrated into one unit.

Embodiments of the invention may further comprise an apparatus, e.g. encoder and/or decoder, which comprises a processing circuitry configured to perform any of the methods and/or processes described herein.

Embodiments of the invention, e.g. of the encoder 100 and/or decoder 200, may be implemented as hardware, firmware, software or any combination thereof. For example, the functionality of the encoder/encoding or decoder/decoding may be performed by a processing circuitry with or without firmware or software, e.g. a processor, a microcontroller, a digital signal processor (DSP), a field programmable gate array (FPGA), an application-specific integrated circuit (ASIC), or the like.

The functionality of any of the embodiments, e.g. the encoder 100 (and corresponding encoding method 100) and/or decoder 200 (and corresponding decoding method 200), may be implemented by program instructions stored on a computer readable medium. The program instructions, when executed, cause a processing circuitry, computer, processor or the like, to perform the steps of the encoding and/or decoding methods. The computer readable medium can be any medium, including non-transitory storage media, on which the program is stored such as a Blu ray disc, DVD, CD, USB (flash) drive, hard disc, server storage available via a network, etc.

An embodiment of the invention comprises or is a computer program comprising program code for performing any of the methods described herein, when executed on a computer.

An embodiment of the invention comprises or is anon-transitory computer readable medium comprising a program code that, when executed by a processor, causes a computer system to perform any of the methods described herein.

### LIST OF REFERENCE SIGNS

FIG. 1

100 Encoder

103 Picture block

102 Input (e.g. input port, input interface)

104 Residual calculation [unit or step]

105 Residual block

106 Transformation (e.g. additionally comprising scaling) [unit or step]

107 Transformed coefficients

108 Quantization [unit or step]

109 Quantized coefficients

110 Inverse quantization [unit or step]

111 De-quantized coefficients

112 Inverse transformation (e.g. additionally comprising scaling) [unit or step]

113 Inverse transformed block

114 Reconstruction [unit or step]

115 Reconstructed block

116 (Line) buffer [unit or step]

117 Reference samples

120 Loop filter [unit or step]

121 Filtered block

130 Decoded picture buffer (DPB) [unit or step]

142 Inter estimation (or inter picture estimation) [unit or step]

143 Inter estimation parameters (e.g. reference picture/reference picture index, motion vector/offset)

144 Inter prediction (or inter picture prediction) [unit or step]

145 Inter prediction block

152 Intra estimation (or intra picture estimation) [unit or step]

153 Intra prediction parameters (e.g. intra prediction mode)

154 Intra prediction (intra frame/picture prediction) [unit or step]

155 Intra prediction block

162 Mode selection [unit or step]

165 Prediction block (either inter prediction block 145 or intra prediction block 155)

170 Entropy encoding [unit or step]

171 Encoded picture data (e.g. bitstream)

172 Output (output port, output interface)

231 Decoded picture

FIG. 2

200 Decoder

202 Input (port/interface)

204 Entropy decoding

209 Quantized coefficients

210 Inverse quantization

211 De-quantized coefficients

212 Inverse transformation (scaling)

213 Inverse transformed block

214 Reconstruction (unit)

215 Reconstructed block

216 (Line) buffer

217 Reference samples

220 Loop filter (in loop filter)

221 Filtered block

230 Decoded picture buffer (DPB)

231 Decoded picture

232 Output (port/interface)

244 Inter prediction (inter frame/picture prediction)

245 Inter prediction block

254 Intra prediction (intra frame/picture prediction)

255 Intra prediction block

260 Mode selection

265 Prediction block (inter prediction block 245 or intra prediction block 255)

FIG. 3

300 Coding system

310 Source device

312 Picture Source

313 (Raw) picture data

314 Pre-processor/Pre-processing unit

315 Pre-processed picture data

318 Communication unit/interface

320 Destination device

322 Communication unit/interface

326 Post-processor/Post-processing unit

327 Post-processed picture data

328 Display device/unit

330 transmitted/received/communicated (encoded) picture data

FIG. 4

400 Video coding device

410 Ingress ports

420 Receiver units (Rx)

430 Central processing unit (CPU)

440 Transmitter units

450 Egress ports

460 Memory

470 Coding module

FIG. 5

500 apparatus

510 feature extractor

520 feature encoder

522 optional differential encoding

530 bitstream multiplexer

FIG. 6

600 apparatus

FIG. 7

700 apparatus

710 bitstream de-multiplexer

720 feature decoder

722 optional differential decoding

730 CV analyzer

732 feature analyzer

734 feature locator

FIG. 8

800 apparatus

FIG. 9

900 apparatus

910 quantizer

920 de-quantizer

FIG. 10

1000 apparatus

1310 face recognition

FIG. 11

1100 feature codec FIG. 12

1200 metadata container

FIG. 13

1300 Computer vision system 1310 face recognition

1320 video retrieval

1330 video storage

FIG. 14

1400 Computer vision system

FIG. 15

1500 face recognition

1510 image frame

1520 image patch of the frame

1530 convolutional neural network CNN

1540 feature

1550 table

What is claimed is:

1. An apparatus (500, 600) for encoding a video comprising:
a processing circuitry configured to:
encode (100) the video into a video bitstream;
extract (510) an image feature from the video;
encode (520) the image feature into a feature bitstream; and
multiplex (530) the feature bitstream and the video bitstream into an output bitstream.

2. The apparatus according to claim 1, wherein the processing circuitry is further configured to extract the image feature for a frame of the video.

3. The apparatus according to claim 1, wherein the processing circuitry is further configured to multiplex the feature bitstream and the video bitstream into the output bitstream, wherein the multiplexing defines an association between the video bitstream pertaining to a video frame and the feature bitstream pertaining to said frame.

4. The apparatus according to claim 1, wherein the multiplexing includes including the image feature of the video into a sequence enhancement information SEI message belonging to frame header information of the video.

5. The apparatus according to claim 1, wherein the processing circuitry is further configured to encode the image feature by differential encoding comprising:
reconstructing (200) from the video bitstream the video;
extracting (510) the image feature from the reconstructed video;
determining a differential image feature by subtracting the extracted image feature of the reconstructed video from the extracted image feature of the video; and
encoding (520) the differential image feature into the feature bitstream.

6. The apparatus according to claim 1, wherein the image feature is any of a scale invariant feature transform, SIFT, speeded up robust features, SURF, binary robust independent elementary features, BRIEF, or a feature extracted by machine-learning based models.

7. An apparatus (700, 800) for reconstructing a video, the apparatus comprising
a processing circuitry configured to
de-multiplex (710) an input bitstream of an encoded video into a video bitstream and a feature bitstream;
decode (200) from the video bitstream the video;
decode (720) from the feature bitstream an image feature of the video; and
locate (734) the image feature in the video.

8. The apparatus according to claim 7, wherein the image feature is for a frame of the video.

9. The apparatus according to claim 7, wherein the input bitstream contains the feature bitstream and the video bitstream in a multiplexing manner, wherein the multiplexing defines an association between the video bitstream pertaining to a video frame and the feature bitstream pertaining to said frame, and the processing circuitry is further configured to de-multiplex the input bitstream into the video bitstream and the feature bitstream according to said frame.

10. The apparatus according to claim 7, wherein the input bitstream contains the image feature in a sequence enhancement information SEI message belonging to frame header information of the video in a multiplexing manner, and the processing circuitry is further configured to de-multiplex from the SEI message the image feature.

11. The apparatus according to claim 7, wherein the processing circuitry is further configured to decode the feature bitstream, including a differential image feature of the video, by differential decoding comprising:
extracting (510) the image feature from the reconstructed video; and
determining the image feature of the video by adding the extracted image feature of the reconstructed video to the differential image feature.

12. The apparatus according to claim 7, wherein the image feature is any of scale invariant feature transform, SIFT, speeded up robust feature, SURF, binary robust independent elementary feature, BRIEF, or a feature extracted by machine-learning based models.

13. A method for encoding a video comprising
encoding the video into a video bitstream;
extracting an image feature from the video;
encoding the image feature into a feature bitstream; and
multiplexing the feature bitstream and the video bitstream into an output bitstream.

14. A method for reconstructing a video, the method comprising:
de-multiplexing from an input bitstream a video bit-stream and a feature bit-stream;
decoding from the video bitstream the video;
decoding from the feature bitstream an image feature of the video; and
locating the image feature in the video.

15. A computer-readable non-transitory medium storing a program, including instructions which when executed on a processor cause the processor to perform the method according to claim 13.
